(19) United States
(12) Patent Application Publication
(10) Pub. No.: US 2026/0364979 A1
(43) Pub. Date: Nov. 19, 2026

(54) WIRELESS MONITORING SYSTEM FOR TUBELESS TIRES

(71) Applicant: Jason Carnahan, Meridian, ID (US)

(72) Inventor: Jason Carnahan, Meridian, ID (US)

(21) Appl. No.: 19/754,660

(22) Filed: Jul. 27, 2026

Related U.S. Application Data
(63) Continuation-in-part of application No. 18/969,179, filed on Dec. 4, 2024, now Pat. No. 12,709,122.
(60) Provisional application No. 63/617,983, filed on Jan. 5, 2024.

(51) Int. Cl. B60C 23/04

(52) U.S. Cl. CPC B60C 23/0493

(57) ABSTRACT

A tire pressure sensor assembly for a tubeless tire includes a module having a support structure that carries a pressure sensor and a wireless transmitter, together with a fastening structure that engages a retention feature of the support structure and mechanically retains the module against an interior surface of the tubeless tire in place of an adhesive bond. The fastening structure may be a post received through an aperture in the support structure, a flexible pocket that receives an edge of the support structure, or a plug body that is received in a hole formed through a carcass of the tubeless tire and both seals the hole and retains the module. The module and the plug body may be provided as an aftermarket kit for installation into an existing tubeless tire.

### PRIORITY APPLICATIONS

This application is a continuation-in-part application of U.S. patent application Ser. No. 18/969,179, filed Dec. 4, 2024, which application claims the benefit of priority to U.S. Provisional Application Ser. No. 63/617,983, filed Jan. 5, 2024, the contents of all which are incorporated herein by reference in their entireties.

### BACKGROUND

Tubeless tires are used on bicycles, motorcycles, automobiles, and other wheeled vehicles. During operation, a tubeless tire is subject to repeated deformation, vibration, temperature changes, moisture, and contact with tire sealant.

These conditions can make it difficult to maintain the position of an object mounted within the tire over the service life of the tire. Separation or displacement of the object may interfere with its intended operation and may require removal of the tire for inspection or servicing.

### BRIEF DESCRIPTION OF THE DRAWINGS

To easily identify the discussion of any particular element or act, the most significant digit or digits in a reference number refer to the figure number in which that element is first introduced.

FIG. 1 is an orthogonal view illustrating a wireless tire pressure and sealant monitoring system, featuring a wireless sensor module encapsulated by printed circuit board (PCB) potting sealant, which houses various sensors interconnected with a near field communication (NFC) processor, according to some examples.

FIG. 2 is a cross-sectional view illustrating a tubeless tire assembly with a tire pressure sensor module integrated within the tire mounted on a rim, according to some examples.

FIG. 3 presents two cross-sectional views illustrating a tubeless tire incorporating a sealant monitoring system, demonstrating how the monitoring system can indicate variable sealant distribution within the tire, according to some examples.

FIG. 4 is a circuit diagram illustrating a wireless sensor module, detailing its electrical connections and components, according to some examples.

FIG. 5 is a flowchart illustrating the process of monitoring tire parameters in tubeless tires, according to some examples.

FIG. 6 is a flowchart illustrating a sealant level measurement and transmission method within a tubeless tire system, according to some examples.

FIG. 7 is a flowchart illustrating a sealant-level detection method for a tire, according to some examples.

FIG. 8 is a block diagram illustrating a tire pressure monitoring system flow, which begins with a pressure-sensing chip detecting the tire pressure, according to some examples.

FIG. 9 is a flowchart illustrating the wireless transmission of tire sensor data, according to some examples.

FIG. 10 is a sequence diagram illustrating a near field communication (NFC) Data Transmission Process which outlines operations involved in transmitting data from a sensor to an NFC reader, according to some examples.

FIG. 11 is a diagrammatic representation illustrating a machine in the form of a computer system within which a set of instructions may be executed for causing the machine to perform any one or more of the methodologies discussed herein, according to some examples.

FIG. 12 is a view illustrating a wireless sensor module mechanically retained against an interior surface of a tubeless tire by flexible corner or edge holders, according to some examples.

FIG. 13 is a view illustrating a wireless sensor module retained against an interior surface of a tubeless tire by a fastening post, including an integrally formed fastening-post configuration and an aftermarket rubber post or plug configuration, according to some examples.

FIG. 14 is a cross-sectional view illustrating a wireless sensor module mechanically retained against an interior surface of a tubeless tire by a fastening post and a retainer clip, according to some examples.

FIG. 15 is a cross-sectional view illustrating a wireless sensor module mechanically retained within a tubeless tire by an aftermarket tire plug, according to some examples.

FIG. 16 is a cross-sectional view illustrating a tire pressure sensor assembly including a module retained against an interior surface of a tubeless tire by a fastening structure, according to some examples.

FIG. 17 is a cross-sectional view illustrating two species of a post-type fastening structure for retaining a module against an interior surface of a tubeless tire, according to some examples.

FIG. 18 is a cross-sectional view illustrating a plug body providing sealing engagement within a hole formed through a tire carcass and retention of a module against an interior surface of a tubeless tire, according to some examples.

FIG. 19 is a view illustrating a flexible pocket retaining an edge of a support structure against an interior surface of a tubeless tire, according to some examples.

FIG. 20 is a view illustrating a tire pressure sensing kit including a plug body and a module prior to installation in a tubeless tire, according to some examples.

FIG. 21 is a cross-sectional view illustrating a tire pressure sensing device mounted onto a valve stem of a tire, according to some examples.

FIG. 22 is a flowchart illustrating a sealant-intrusion detection method for a tire pressure sensing device mounted onto a valve stem of a tire, according to some examples.

FIG. 23 is a view illustrating a tire pressure sensing system including a module mounted within a tubeless tire and a tire pressure sensing device mounted onto a valve stem of the tubeless tire, according to some examples.

### DETAILED DESCRIPTION

The present disclosure describes a wireless sealant and pressure monitoring system for tubeless tires. The system includes an integrated wireless component, which is strategically positioned inside a tubeless tire. This integrated wireless component comprises several integral parts that work in unison to monitor the sealant level and tire pressure.

The first and second conductive sealant sensor pads are part of the integrated wireless component. These sensor pads are exposed to the interior of the tubeless tire and are designed to detect the presence and amount of sealant within the tire. The sensor pads are made of a conductive material that can detect the presence of sealant based on its ability to conduct electrical current. The sensor pads are positioned in close proximity to each other, typically approximately ¼ inch apart, to facilitate accurate measurement of the sealant level.

The current sensor is electrically connected to the first and second conductive sealant sensor pads. The current sensor is configured to measure an electrical current flowing between the first and second sealant sensor pads. This current measurement provides a direct indication of the sealant level inside the tubeless tire. The higher the current flow between the sensor pads, the higher the sealant level, and vice versa.

The pressure sensor is another part of the integrated wireless component. The pressure sensor is designed to measure the pressure inside the tubeless tire. In some cases, the pressure sensor may be a piezoresistive pressure sensor, which measures pressure based on the change in electrical resistance that occurs when mechanical strain is applied to the sensor. The pressure sensor can measure pressures in a range of 5 to 60 PSI, making it suitable for monitoring the pressure levels in tubeless bicycle tires, which typically operate at lower pressures compared to automotive tires.

The wireless transmitter is in communication with both the current sensor and the pressure sensor. The wireless transmitter is configured to transmit data corresponding to the measured electrical current and measured pressure. This data transmission allows the sealant level and tire pressure information to be wirelessly communicated to an external device, such as a mobile phone, for real-time monitoring and display.

In addition to the adhesive-based mounting of the wireless sensor module described above, the present disclosure also describes a mechanical fastening structure for retaining a sensor module against an interior surface of a tubeless tire without an adhesive bond as the means of attachment. The fastening structure engages a retention feature of a support structure that carries a pressure sensor and a wireless transmitter, and is described below in several forms, including a post received through an aperture in the support structure, a plug body that both seals a hole formed through the tire carcass and anchors the support structure, and a flexible pocket that receives and retains an edge of the support structure. These fastening structures may be formed integrally with a tire during manufacture, or provided as part of an aftermarket kit for installation into an already-manufactured tire.

The present disclosure further describes a tire pressure sensing device configured to mount onto a tire's valve stem rather than within the tire's interior. This valve-stem-mounted device carries its own pressure sensor, humidity sensor, controller, and wireless transmitter, and is powered by an internal battery rather than by wirelessly harvested energy, allowing it to sense tire conditions and to transmit data using a longer-range wireless technology on an ongoing basis.

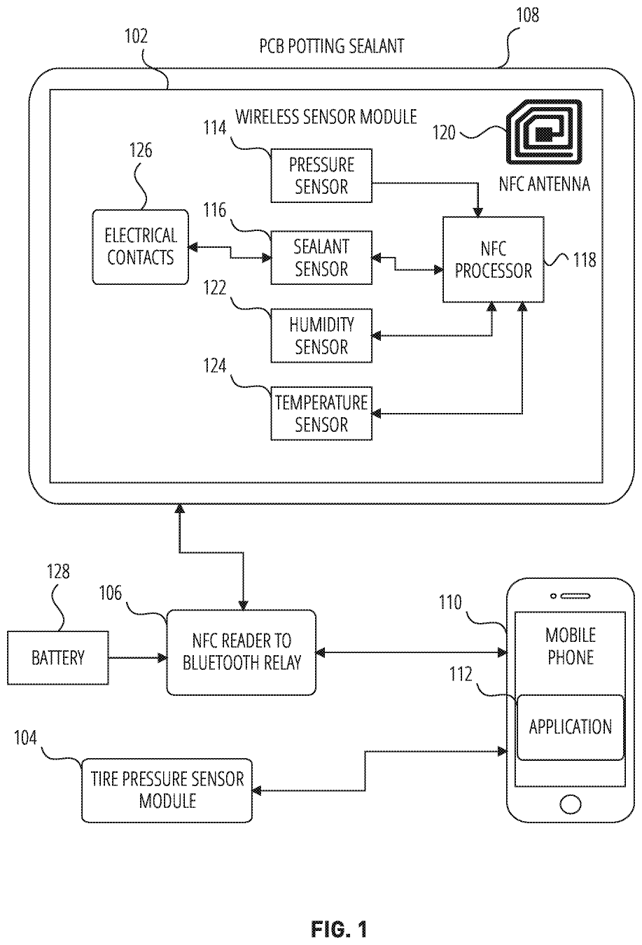

Referring to FIG. 1, the wireless sensor module 102, according to some examples, which includes a printed circuit board (PCB) of a predetermined shape designed to fit within the contours of a tubeless tire, is partially encapsulated by a PCB potting sealant 108. The PCB is composed of a durable material capable of withstanding the flexing and vibrations experienced within the tire environment.

This encapsulation with PCB potting sealant 108 protects the wireless sensor module 102 from moisture ingress and corrosion, conditions that are prevalent inside a tubeless tire due to exposure to the elements and the tire's operational stresses. The PCB potting sealant 108, selected for its robust adhesion properties and compatibility with the PCB materials, covers the wireless sensor module 102 thoroughly, except detection components of a pressure sensor 114, sealant sensor 116, a humidity sensor 122, and a temperature sensor 124. For example, the two or more electrical contacts 126 of the sealant sensor 116 are not covered by the PCB potting sealant 108. The electrical contacts 126, crafted from a conductive material resistant to oxidative degradation, are deliberately left unencapsulated and exposed to the interior of the tubeless tire. This strategic exposure is to ensure that the electrical contacts 126 can directly interact with the sealant to enable accurate detection of the sealant level, which is a parameter for the tire's performance and safety.

The wireless sensor module 102 comprises several integral components that work in unison to monitor the tire pressure and sealant level. These components include a pressure sensor 114, a sealant sensor 116, a humidity sensor 122, and a temperature sensor 124. All these sensors are mounted on the PCB and interconnected through carefully routed conductive traces that provide electrical connectivity. The NFC processor 118, which serves as the central hub for data processing, is also mounted on the PCB and electrically connected to each sensor. It processes the sensor data, converting it from analog to digital signals as appropriate, and prepares it for wireless transmission. The layout of the PCB is designed to optimize the space and ensure that the sensors are positioned to accurately detect their respective parameters without interference. The components are soldered onto the PCB using materials and techniques that enhance their durability and resistance to the tire's operational environment.

The NFC processor 118, a central component of the wireless sensor module, is connected to an NFC antenna 120. This connection is integral to the operation of the system as it enables wireless communication between the sensor module and an external reader device. The NFC antenna 120 serves as the conduit for this communication, receiving and transmitting signals to and from the NFC processor 118.

The NFC antenna 120 is designed to operate at a specific frequency that allows for efficient and reliable data transmission. It captures the data signals from the NFC processor 118, which contains the processed sensor data, and transmits these signals wirelessly to the external reader device. This wireless transmission of data enables real-time monitoring of the tire pressure and sealant levels, providing the user with up-to-date information about the conditions inside the tubeless tire.

Furthermore, the NFC antenna 120 also plays a role in powering the wireless sensor module. During an NFC transaction, a small amount of energy is transferred from the external reader device to the NFC antenna 120. This energy is then harvested by the NFC processor 118and used to power the sensor module, eliminating the dependency on an internal power source. This self-powered operation enhances the reliability and longevity of the sensor module, ensuring its continuous operation even in the challenging environment of a tubeless tire.

In some examples, the NFC antenna 120 may be designed to operate at a different frequency that still allows for efficient and reliable data transmission. This may include frequencies within the range of 13.56 MHz to 14.56 MHz, which are commonly used for NFC communication. This variation may provide flexibility in the design of the wireless sensor module and allow it to adapt to different NFC standards or regulations.

In some examples, the NFC antenna 120 may be designed with a different shape or size to optimize its performance. For example, the antenna may be designed with a larger surface area to capture more energy from the NFC transaction, enhancing the power supply to the sensor module. Alternatively, the antenna may be designed with a more compact size to fit within smaller or narrower tubeless tires.

In some examples, the NFC antenna 120 may be replaced with a different type of wireless antenna, such as a Bluetooth or Wi-Fi antenna. This may allow the wireless sensor module to communicate with a wider range of external reader devices, enhancing the versatility of the system. However, this variation would require a different method of powering the sensor module, as Bluetooth and Wi-Fi antennas do not provide energy harvesting capabilities like NFC antennas.

In some examples, the energy harvested by the NFC processor 118 may be stored in a small energy storage device, such as a capacitor or a rechargeable battery, before being used to power the sensor module. This may provide a more stable power supply to the sensor module and allow it to operate even when the NFC transaction is not taking place. This variation may enhance the reliability and longevity of the sensor module, ensuring its continuous operation even in the challenging environment of a tubeless tire.

In some examples, the NFC processor 118 may be designed with a power management feature that regulates the use of the harvested energy. This feature may prioritize the power supply to the pressure sensor and the current sensor, ensuring that these sensors can operate effectively even when the harvested energy is low. This variation may enhance the accuracy and reliability of the pressure and sealant level measurements, improving the overall performance of the system.

The pressure sensor 114 is designed to measure the pressure inside the tubeless tire. In some cases, the pressure sensor 114 may comprise an STMicroelectronics ILPS22QS chip, which is a compact pressure sensor capable of sensing pressures up to 60 PSI. This range is suitable for monitoring the pressure levels in tubeless bicycle tires, which typically operate at lower pressures compared to automotive tires.

The sealant sensor 116 is specifically engineered to detect the level of sealant within the tubeless tire. The sensor operates on the principle of electrical conductivity, a property that varies with the presence and amount of sealant in the tire. The sealant sensor 116 is designed with two or more electrical contacts 126, which serve as the points between which conductivity is measured.

As the level of sealant in the tire increases, the sealant, being a conductive liquid, allows for a greater flow of electrical current between the electrical contacts 126. This results in an increase in the conductivity between the contacts. Conversely, when the level of sealant decreases, less sealant is present between the contacts to facilitate the flow of electrical current. This leads to a decrease in conductivity between the electrical contacts 126.

This change in conductivity, whether an increase or decrease, provides a direct and reliable indication of the sealant level inside the tubeless tire. By continuously monitoring the conductivity between the electrical contacts 126, the sealant sensor 116 can provide real-time data on the sealant level within the tire. This data is invaluable for maintaining the performance and safety of the tire, as it allows the user to ensure that the sealant level is adequate and replenish it if it falls below the recommended level.

In some examples, the sealant sensor 116 may be designed with three or more electrical contacts to measure conductivity. This may provide a more detailed and accurate measure of the sealant level, as it allows for multiple conductivity readings at different points within the tire. The additional contacts may be arranged in a linear or radial pattern, or any other configuration that allows for effective measurement of the sealant level.

In some examples, the sealant sensor 116 may be designed to measure the resistance between the electrical contacts, instead of the conductivity. Resistance is the inverse of conductivity, and measuring resistance may provide an alternative method for detecting the sealant level. As the level of sealant increases, the resistance between the contacts decreases, and vice versa. This resistance measurement may provide a direct and reliable indication of the sealant level inside the tubeless tire.

In some examples, the sealant sensor 116 may be designed to measure the capacitance between the electrical contacts. Capacitance is a property that varies with the presence and amount of a dielectric material, such as the sealant, between the contacts. As the level of sealant increases, the capacitance between the contacts increases, and vice versa. This capacitance measurement may provide another method for detecting the sealant level.

The humidity sensor 122 is designed to measure the humidity level inside the tubeless tire. The presence of sealant inside the tire increases the humidity level, and by detecting this humidity level, the humidity sensor 122 can indirectly measure the sealant level.

In some examples, the humidity sensor 122 may be replaced or supplemented with a different type of sensor that can indirectly measure the sealant level. For example, a temperature sensor may be used, as the presence of sealant inside the tire can affect the temperature within the tire. By detecting the temperature inside the tire, the temperature sensor can indirectly measure the sealant level.

The temperature sensor 124 may be designed to measure the temperature inside the tubeless tire. This temperature data can provide additional information about the tire's operating conditions, which can be useful for diagnosing potential issues or optimizing the tire's performance.

The NFC processor 118 may be a small single-chip solution that allows for NFC power, has an i2c interface for communication with other chips, and has an analog-to-digital converter and current sensor to gather pressure and/or sealant information. The NFC processor 118 is connected to an NFC antenna 120, which can be integrated onto a printed circuit board of the wireless sensor module 102 or can be a flexible standard antenna connected to a small NFC sensor PCB. The NFC antenna 120 is responsible for receiving NFC signals and powering the module during an NFC transaction.

The wireless sensor module 102 is configured to relay tire pressure data, sealant level data, and temperature data to a wireless reader device using an NFC data exchange format. This wireless transmission of data allows the tire pressure and sealant level information to be accessed in real-time, providing a convenient and efficient method for monitoring and maintaining the performance and safety of tubeless tires.

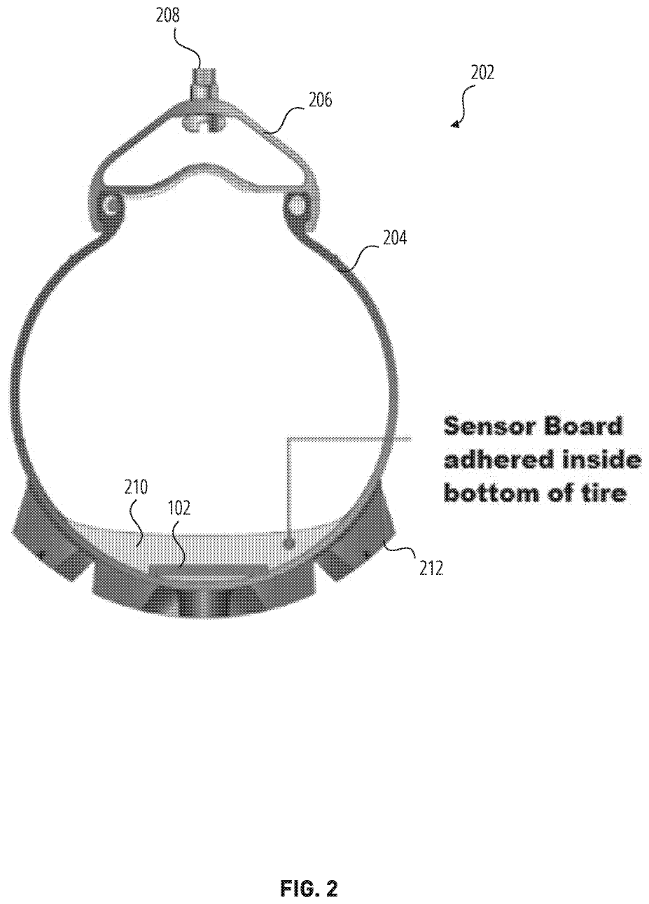

Referring to FIG. 2, a cross-sectional view of a tubeless tire assembly, according to some examples, is depicted, where a tire pressure sensor module 104 is integrated within the tire 204. The tire 204 is mounted on a rim 206, and a spoke rim 206 connects the rim 206 to the hub at the center. Sealant 210 is applied along the interior surface of the tire 204, partially surrounding the wireless sensor module 102. The exterior of the tire features a tire tread 212, which provides the contact surface for the vehicle's movement.

The wireless sensor module 102 is strategically positioned and adhered to the bottom of the tire's interior to effectively monitor pressure within the enclosed space formed by the tire 204 and rim 206. The wireless sensor module 102 is designed to be in direct contact with the sealant 210, allowing it to accurately measure the sealant level inside the tire. The wireless sensor module 102 is also in close proximity to the interior surface of the tire 204, enabling it to accurately measure the tire pressure.

In some cases, the wireless sensor module 102 may be adhered to an inside surface of the tubeless tire 204 at a location marked on the outside surface of the tubeless tire 204. This marking can provide a visual guide for the placement of the wireless sensor module 102, ensuring that it is positioned in the correct location for accurate measurement of the sealant level and tire pressure.

In some cases, the wireless sensor module 102 can be adhered to an inside surface of the tubeless tire 204 at a location corresponding to an existing marking on the outside surface of the tubeless tire 204. This existing marking can be a manufacturer's logo, a specification label, or any other marking that is already present on the outside surface of the tire 204. Using an existing marking for the placement of the wireless sensor module 102 can simplify the installation process and ensure that the wireless sensor module 102 is positioned in the correct location for accurate measurement of the sealant level and tire pressure.

In some examples, the wireless sensor module 102 may include multiple sealant sensors positioned at different locations within the tire. This may provide a more comprehensive measure of the sealant distribution within the tire, as it allows for sealant level measurements at multiple points. The data from these multiple sensors may be combined to provide a detailed map of the sealant distribution within the tire.

In some examples, the wireless sensor module 102 may be designed to measure the viscosity of the sealant 210 in addition to its level. The viscosity of the sealant can affect its ability to seal punctures and its distribution within the tire. By measuring the viscosity, the system can provide additional information about the condition and performance of the sealant.

In some examples, the wireless sensor module 102 may be designed to measure the pH of the sealant. The pH of the sealant can affect its performance and longevity, and by measuring the pH, the system can provide additional information about the condition of the sealant.

While the wireless sensor module 102 is described above as being adhered to the inside surface of the 204, it can be integrated into tubeless tires through multiple manufacturing and installation methods:

Adhesive Installation: As noted above, the wireless sensor module 102 can be adhered to an inside surface of the tubeless tire using a specialized adhesive coating. This installation method allows for precise positioning of the sensor module, typically at a location corresponding to an existing marking on the outside surface of the tubeless tire for easy reference. The adhesive is compatible with both the tire material and the PCB potting sealant that encapsulates the sensor module.

Integrated Mesh Pocket: During the tire manufacturing process, in some examples, a reinforced mesh pocket structure can be incorporated into the inner liner of the tire. This mesh pocket may be positioned at an accessible monitoring location within the tire, for example, at the bottom portion of the tire's interior. The mesh pocket may be constructed from a flexible, high-strength material compatible with the tire's rubber compound and designed to securely hold the wireless sensor module while allowing it to maintain contact with the tire sealant. The pocket may include
A flexible mesh retention structure that allows sealant flow while securing the sensor
Reinforced pocket walls integrated with the tire's inner liner
A secure closure mechanism for aftermarket sensor installation
Drainage channels to prevent sealant pooling around the sensor

Molded Integration: For permanent integration, in some examples, the wireless sensor module 102 can be directly molded into the tire during the manufacturing process. This method may involve:
Positioning the wireless sensor module 102 within the tire mold before the final cure
Encapsulating the sensor in a protective housing designed to withstand the vulcanization process
Incorporating specialized heat-resistant material to protect the sensor's electronic components during the high-temperature curing process
Including dedicated sealant flow channels around the molded sensor housing to maintain proper sealant contact with the electrical contacts
Integration with the tire's inner liner reinforcement structure to ensure long-term durability

Each integration method maintains the sensor's ability to accurately measure both pressure and sealant levels while ensuring the sensor's electrical contacts remain exposed to the tire's interior environment for proper functionality. The choice of integration method can be based on manufacturing capabilities, cost considerations, and whether the sensor is intended for factory installation or aftermarket addition.

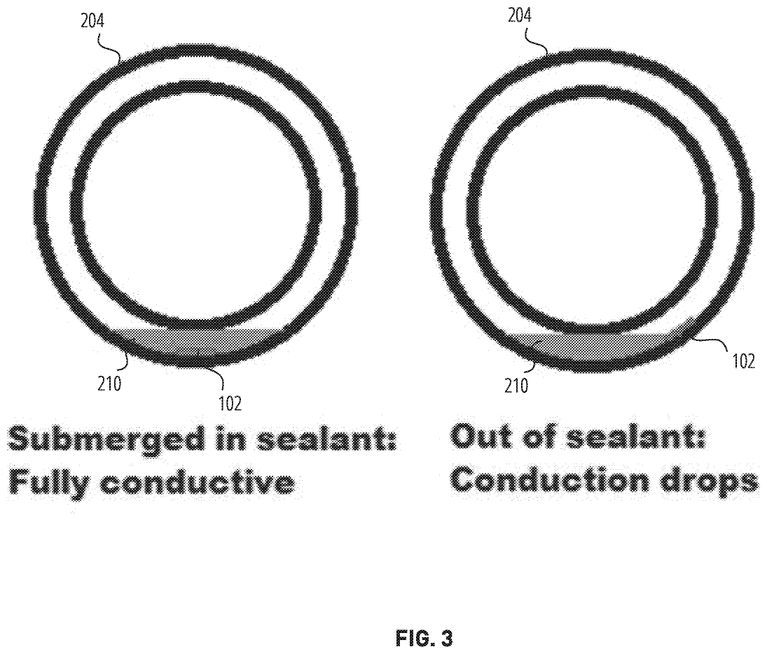

Referring to FIG. 3, two cross-sectional views of a tubeless tire incorporating a sealant monitoring system, according to some examples, are presented. Electrical contacts 126 that form part of a sensor pad, which is part of the wireless sensor module 102, are shown in two different states, each representing a different level of sealant within the tire 204.

In the right view, a portion of the sensor pad is depicted to indicate an area where the sealant level is low. This is represented by a drop in conduction between the electrical contacts 126 of the sensor pad, suggesting a lower sealant level at that segment. This drop in conduction is detected by the sealant sensor 116, which measures the electrical current flowing between the electrical contacts 126. When the sealant 210 level is low, the current flow between the electrical contacts 126 is reduced, resulting in a lower conductivity reading. This reading is then processed by the NFC processor 118 and transmitted to the external device (e.g., the mobile phone 110) via the wireless transmitter (e.g., the NFC reader to Bluetooth relay 106), providing an indication of the sealant level in that segment of the tire 204.

In the left view, the same sensor pad is depicted submerged in sealant 210 and thus fully conductive. This indicates a sufficient level of sealant at that location within the tire 204. When the sensor pad is fully submerged in sealants 210, the current flow between the electrical contacts 126 is maximized, resulting in a higher conductivity reading. This reading is then processed and transmitted in the same manner as described above, providing an indication of a sufficient sealant level in that segment of the tire 204.

Both views demonstrate how the monitoring system can indicate variable sealant distribution within the tire 204. By measuring the conductivity between the electrical contacts 126 at different locations within the tire 204, the system can provide a detailed map of the sealant distribution within the tire 204. This information can be invaluable for maintaining the performance and safety of the tire 204 as it allows the user to ensure that the sealant is evenly distributed throughout the tire 204 and to replenish the sealant if it falls below the recommended level in any segment of the tire 204.

In some cases, the wireless sensor module 102 may be configured to detect the level of sealant by rotating the tubeless tire 204 to move the sealant over the two or more electrical contacts 126 of the wireless sensor module 102. This rotation can cause the sealant to flow over the sensor pad, changing the conductivity reading and providing a dynamic measure of the sealant level within the tire 204. This method can provide a more accurate and comprehensive measure of the sealant level, as it takes into account the fluid nature of the sealant and its tendency to move around inside the tire 204.

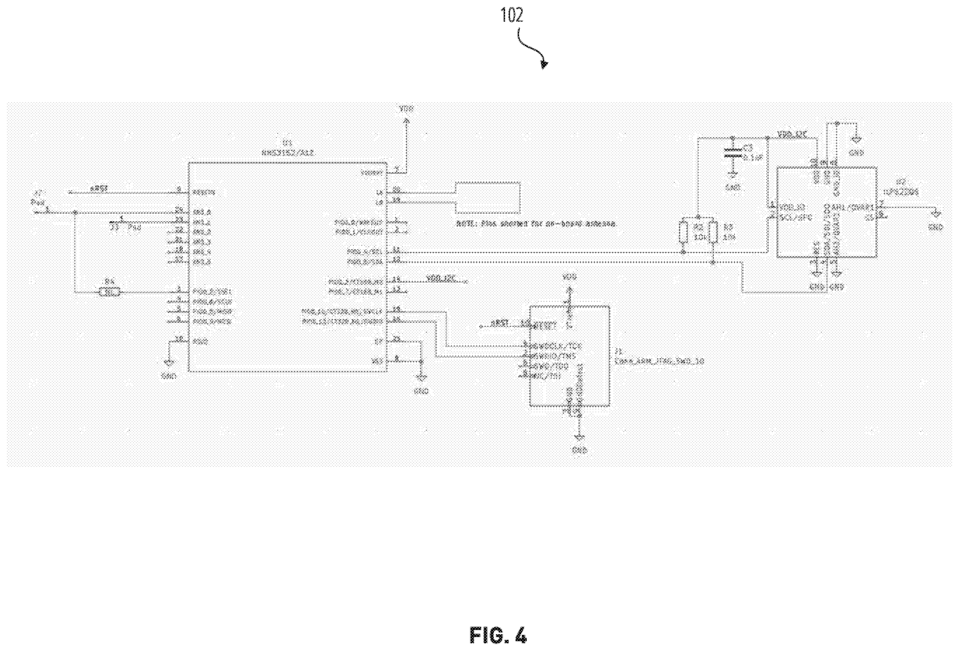

Referring to FIG. 4, a circuit diagram of a wireless sensor module 102, according to some examples, is illustrated, detailing its electrical connections and components. The wireless sensor module 102 is a compact and efficient device that is designed to measure the pressure and sealant levels inside a tubeless tire. It comprises several integral components that work in unison to monitor these parameters and transmit the data wirelessly to an external device.

The wireless sensor module 102 is connected to decoupling capacitors. These capacitors are designed to filter out any high-frequency noise in the power supply, ensuring a stable and clean power supply for the operation of the wireless sensor module 102. This can enhance the accuracy and reliability of the measurements taken by the wireless sensor module 102.

A Schottky diode is positioned within the circuit to regulate the flow of current within the system. The Schottky diode allows current to flow in one direction but blocks it in the opposite direction. This can prevent any reverse current flow that may potentially damage the components of the wireless sensor module 102.

Pin headers are integrated into the circuit, providing connection points for the various components of the wireless sensor module 102. These pin headers allow for easy assembly and disassembly of the components, facilitating maintenance and repair of the wireless sensor module 102. Additional pin headers are also provided to establish further connectivity options, enhancing the flexibility and adaptability of the wireless sensor module 102.

A communication port serves as an interface for data exchange between the wireless sensor module 102 and the external device. It is designed to facilitate the transmission of the pressure and sealant level data from the wireless sensor module 102 to the external device, enabling real-time monitoring of these parameters.

The wireless sensor module 102 and its components are partially encapsulated within a PCB potting sealant 108. This PCB potting sealant 108 provides a protective coating for the components, shielding them from moisture, corrosion, and other environmental conditions inside the tubeless tire. This can enhance the durability and longevity of the wireless sensor module 102, ensuring reliable operation over extended periods of time.

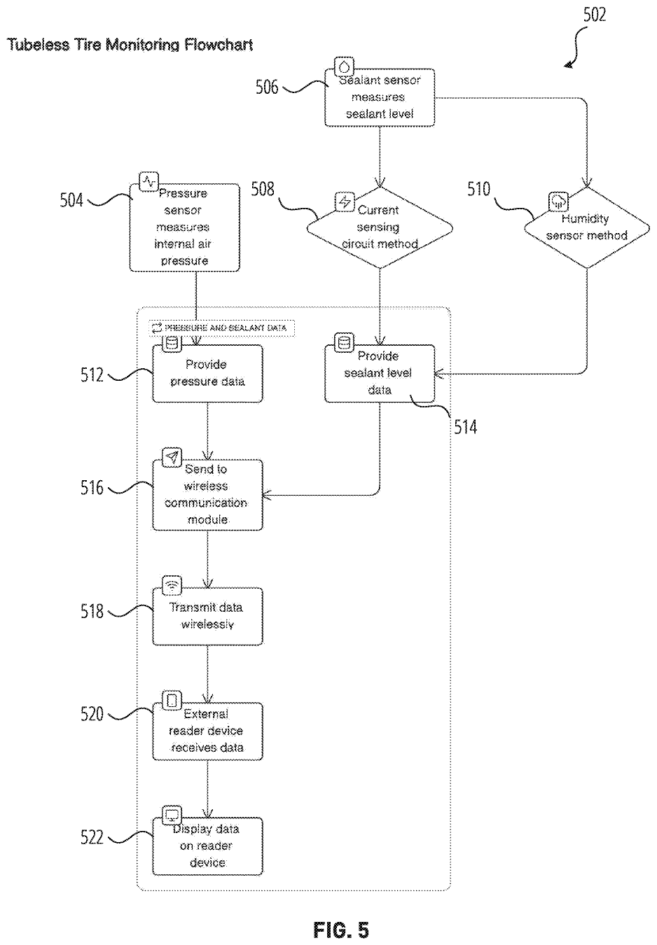

Referring to FIG. 5, a flowchart illustrates a method 502, according to some examples, of monitoring tire parameters in tubeless tires. The method 502 begins with operation 504, where a pressure sensor 114 measures the internal air pressure of the tubeless tire 204. The pressure sensor 114, which can be a piezoresistive pressure sensor, measures the pressure based on the change in electrical resistance that occurs when mechanical strain is applied to the sensor. The pressure sensor 114 can measure pressures in a range of 5 to 60 PSI, making it suitable for monitoring the pressure levels in tubeless bicycle tires, which typically operate at lower pressures compared to automotive tires.

Simultaneously, the sealant level inside the tubeless tire may be measured using two methods.

The first method of measuring sealant levels in a tubeless tire involves the use of a sealant sensor 116,at operation 508. This sealant sensor 116 is designed to measure the level of sealant based on the principle of electrical conductivity. The sealant sensor 116 comprises two or more electrical contacts 126 of a pad that is strategically positioned within the tire 204. These electrical contacts 126 are made of a conductive material and are designed to come into direct contact with the sealant inside the tire.

As the level of sealant 210 in the tire 204 increases, the sealant begins to cover more of the electrical contacts. Given that the sealant is a conductive liquid, it allows for the flow of electrical current between the contacts. Consequently, as more sealant covers the contacts, the conductivity between the contacts increases. Conversely, when the level of sealant decreases, less of the contacts are covered by the sealant, leading to a decrease in conductivity.

This change in conductivity between the electrical contacts provides a direct and reliable indication of the sealant level inside the tubeless tire. The sealant sensor 116 continuously monitors the conductivity between the contacts, providing real-time data on the sealant level. This data is then processed and transmitted to an external device (e.g., the mobile phone 110), allowing the user to monitor the sealant level in real-time. This method 502 of sealant level detection, represented by operation 506 in the flowchart, provides a simple, accurate, and efficient solution for monitoring sealant levels in tubeless tires.

The second method for measuring the sealant level in a tubeless tire 204 involves the use of a humidity sensor 122, as depicted in operation 510 of the flowchart. This method is based on the principle that the presence of sealant inside the tire increases the humidity level within the tire's interior. The humidity sensor 122, which is a part of the wireless sensor module 102, is designed to detect this increase in humidity.

As the sealant is a liquid substance, it naturally increases the humidity level inside the tire. This increase in humidity is directly proportional to the amount of sealant present in the tire. Therefore, by detecting the humidity level, the humidity sensor can indirectly measure the level of sealant inside the tire. This indirect measurement of sealant level provides an additional layer of information, enhancing the accuracy and reliability of the sealant level measurement.

This method of sealant level detection may be particularly useful in situations where the sealant is unevenly distributed within the tire 204 or where the sealant level changes rapidly due to factors such as evaporation or leakage. In such situations, the humidity sensor 122 can provide a more accurate and reliable measure of the overall sealant level within the tire, compared to methods that rely on direct contact with the sealant.

Furthermore, the use of a humidity sensor 122 for sealant level detection also has the advantage of being non-invasive and less prone to interference from the sealant 210 itself. Unlike methods that involve direct contact with the sealant, the humidity sensor 122 does not risk being coated or blocked by the sealant, which can affect the accuracy of the measurements. This makes the humidity sensor 122 a robust and reliable solution for monitoring sealant levels in tubeless tires.

Once the pressure and sealant level data are measured, they are provided to a wireless communication module (e.g., the NFC reader to Bluetooth relay 106), as represented by operation 512 through operation 516. The wireless sensor module 102 is configured to transmit the data corresponding to the measured pressure and sealant level. This data transmission is represented by operation 518 in the flowchart 502.

The transmitted data is then received by an external reader device (e.g., the mobile phone 110 running the application 112).. The external reader device can be a mobile phone or any other device equipped with NFC or Bluetooth capabilities. The reader device decodes the received data and extracts the pressure and sealant level information.

Finally, the pressure and sealant level data are displayed on the reader device, as represented by operation 522 in the flowchart 502. This display can be on a mobile application or any other user interface that can present the data in a readable and understandable format. This completes the monitoring process, providing the user with real-time information about the pressure and sealant level inside the tubeless tire.

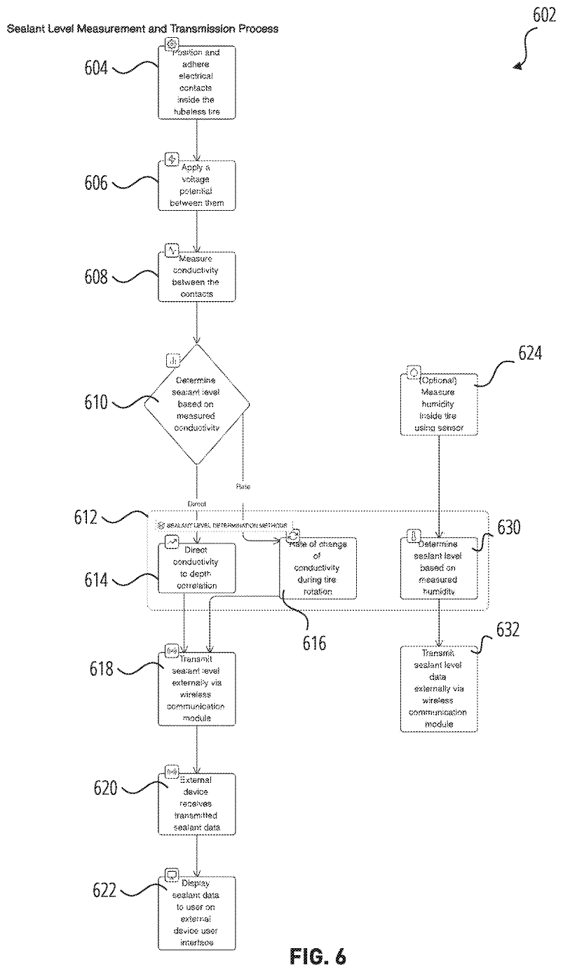

Referring to FIG. 6, a flowchart outlines a sealant level measurement and transmission method 602, according to some examples, within a tubeless tire system. The process begins with operation 604, where electrical contacts 126 are positioned inside the tubeless tire 204. These electrical contacts 126, which are part of the sealant sensor 116, are designed to detect the presence and amount of sealant 210 within the tire 204 based on its ability to conduct electrical current.

Following the positioning of the electrical contacts, a voltage is applied between them during operation 606. This voltage generates an electrical current that flows between the electrical contacts. The magnitude of this current is directly related to the conductivity between the electrical contacts, which in turn is influenced by the level of sealant present between the contacts.

In some scenarios, the sealant sensor 116 may utilize a technique where a voltage is applied to the electrical contacts 126 to induce a pulsing current. This method involves applying a voltage across the electrical contacts in a periodic manner, causing the current to flow in pulses rather than continuously. The pulsing current can provide more detailed information about the sealant level, as it allows for the detection of changes in conductivity over time. This can be particularly useful in situations where the sealant level is changing rapidly, such as during the sealing of a puncture or the addition of new sealant. By monitoring the pulsing current, the system can track these changes in real-time and provide more accurate and timely information about the sealant level.

This pulsing current technique leverages the conductive properties of the sealant to provide a dynamic measure of the sealant level. When the sealant level is high, the pulsing current is strong, indicating a high conductivity between the contacts. Conversely, when the sealant level is low, the pulsing current is weak, indicating a low conductivity between the contacts. This direct correlation between the pulsing current and the sealant level allows for accurate and real-time monitoring of the sealant level.

Furthermore, the pulsing current technique is particularly useful in dynamic situations where the sealant level is changing rapidly. For instance, when a puncture occurs, the sealant rushes to the puncture site to seal it. This rapid movement of the sealant can cause a sudden change in the sealant level at the sensor location. The pulsing current technique can detect this rapid change, providing real-time information about the puncture event and the effectiveness of the sealant in sealing the puncture.

Similarly, when new sealant is added to the tire, it can cause a sudden increase in the sealant level. The pulsing current technique can detect this sudden increase, providing real-time information about the addition of the new sealant and its distribution within the tire. This real-time information can be invaluable for maintaining the performance and safety of the tire, as it allows the user to ensure that the sealant is evenly distributed throughout the tire and to replenish the sealant if it falls below the recommended level in any segment of the tire.

In some instances, the sealant sensor 116 may employ a technique where a voltage is applied to the electrical contacts to induce a modulated current. This method involves applying a voltage across the electrical contacts in a cyclical manner, causing the current to flow in waves rather than continuously. The wave-like current can provide more nuanced information about the sealant level, as it allows for the detection of subtle changes in conductivity over time. This can be particularly useful in situations where the sealant level is fluctuating rapidly, such as during the sealing of a puncture or the addition of new sealant. By monitoring the wave-like current, the system can track these changes in real-time and provide more accurate and timely information about the sealant level.

In some examples, the sealant sensor 116 may utilize a technique where a voltage is applied to the electrical contacts to induce a stepped current. This method involves applying a voltage across the electrical contacts in a stepwise manner, causing the current to flow in steps rather than continuously. The stepped current can provide more detailed information about the sealant level, as it allows for the detection of changes in conductivity over time. This can be particularly useful in situations where the sealant level is changing rapidly, such as during the sealing of a puncture or the addition of new sealant. By monitoring the stepped current, the system can track these changes in real-time and provide more accurate and timely information about the sealant level.

In some examples, the sealant sensor 116 may employ a technique where a voltage is applied to the electrical contacts to induce a ramped current. This method involves applying a voltage across the electrical contacts in a ramped manner, causing the current to flow in a ramp-like pattern rather than continuously. The ramped current can provide more detailed information about the sealant level, as it allows for the detection of changes in conductivity over time. This can be particularly useful in situations where the sealant level is changing rapidly, such as during the sealing of a puncture or the addition of new sealant. By monitoring the ramped current, the system can track these changes in real-time and provide more accurate and timely information about the sealant level.

In some scenarios, the sealant sensor 116 may utilize a technique where a voltage is applied to the electrical contacts to induce a sinusoidal current. This method involves applying a voltage across the electrical contacts in a sinusoidal manner, causing the current to flow in a sinusoidal pattern rather than continuously. The sinusoidal current can provide more detailed information about the sealant level, as it allows for the detection of changes in conductivity over time. This can be particularly useful in situations where the sealant level is changing rapidly, such as during the sealing of a puncture or the addition of new sealant. By monitoring the sinusoidal current, the system can track these changes in real-time and provide more accurate and timely information about the sealant level.

The resulting conductivity between the electrical contacts is then measured in operation 608. This measurement is performed by the current sensor 130, which is electrically connected to the electrical contacts. The current sensor 130 measures the electrical current flowing between the electrical contacts, providing a direct indication of the conductivity between the contacts.

Based on the measured conductivity, the sealant level inside the tubeless tire 204 is determined in operation 610. This determination can be made using one of two methods. The first method involves a direct correlation between the conductivity and the depth of the sealant, as represented by operation 614. In this method, a higher conductivity corresponds to a higher sealant level, and vice versa.

The second method involves an assessment based on the rate of change of conductivity during tire rotation, as represented by operation 616. In this method, the tubeless tire 204 is rotated, causing the sealant 210 to move over the electrical contacts 126. As the sealant moves, the conductivity between the contacts changes, and this change in conductivity is used to determine the sealant level.

An optional method for determining the sealant level is also shown at operation 624 operation 626, which involves measuring the humidity inside the tire using a humidity sensor 122. This method is based on the observation that the presence of sealant inside the tire increases the humidity level. Therefore, by detecting the humidity level inside the tire, the sensor can indirectly measure the sealant level.

Once the sealant level has been determined, it is transmitted externally via a wireless communication module during operation 618 and operation 632. This wireless communication wireless sensor module 102, which can be a near field communication (NFC) transmitter or a Bluetooth transmitter, is configured to transmit the sealant level data to an external device.

The transmitted data is then received by an external device during operation 620. The external device can be a mobile phone 110 or any other device equipped with NFC or Bluetooth capabilities. The device decodes the received data and extracts the sealant level information.

Finally, the sealant level data is displayed to the user on the external device's user interface during operation 622. This display can be on a mobile application or any other user interface that can present the data in a readable and understandable format. This completes the monitoring process, providing the user with real-time information about the sealant level inside the tubeless tire.

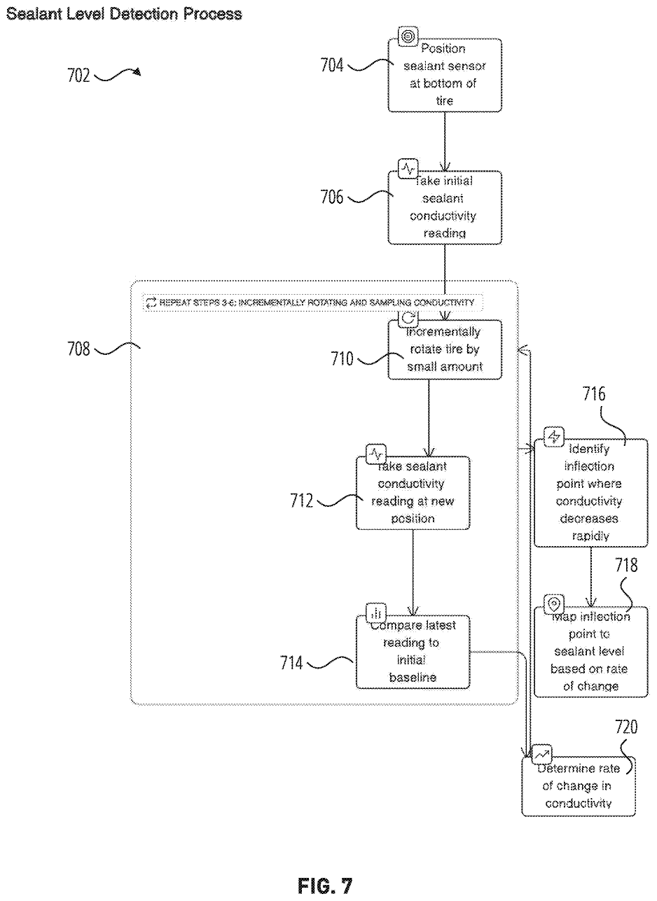

Referring to FIG. 7, a flowchart outlines a sealant-level detection method 702, according to some examples, for a tire. The method 702 starts with operation 704, which involves positioning the sealant sensor 116 at the bottom of the tire 204. The sealant sensor 116, which is part of the wireless sensor module 102, is designed to detect the presence and amount of sealant 210 within the tire 204 based on its ability to conduct electrical current.

Once the sealant sensor 116 is positioned, operation 706 is performed, which involves taking an initial sealant conductivity reading. This reading is taken by a current sensor, which measures the electrical current flowing between the electrical contacts 126 of the sealant sensor 116. The magnitude of this current is directly related to the conductivity between the electrical contacts 126, which in turn is influenced by the level of sealant present between the contacts.

The process then proceeds to operation 710, which involves incrementally rotating the tire 204 by a small amount. This rotation can cause the sealant 210 to move over the electrical contacts of the sealant sensor 116 (as shown in FIG. 3), changing the conductivity reading. After each minor rotation, operation 712 is performed to take a sealant conductivity reading at the new position. This reading is compared to the initial baseline reading during operation 714.

The next steps include operation 716, which involves identifying an inflection point where conductivity decreases rapidly. This inflection point may correspond to the point at which the sealant 210 begins to slide off the electrical contacts 126 due to gravity. This change in sealant contact with the sealant sensor 116 is detected by the current sensor, which observes a decrease in conductivity between the electrical contacts 126. This decrease in conductivity is directly related to the reduction in sealant coverage on the electrical contacts 126.

Following the identification of the inflection point, operation 718 is performed to map the inflection point to the sealant level based on the rate of change of conductivity. The rate of change of conductivity is determined in operation 720, indicating the sealant level within the tire. By carefully monitoring the change in conductivity as the tire is rotated, the system can determine the point at which the sealant begins to slide off the contacts. This point corresponds to the depth of the sealant within the tire. Therefore, this level readout functionality provides a means to check the depth of the sealant within the tire, offering a more comprehensive understanding of the sealant level.

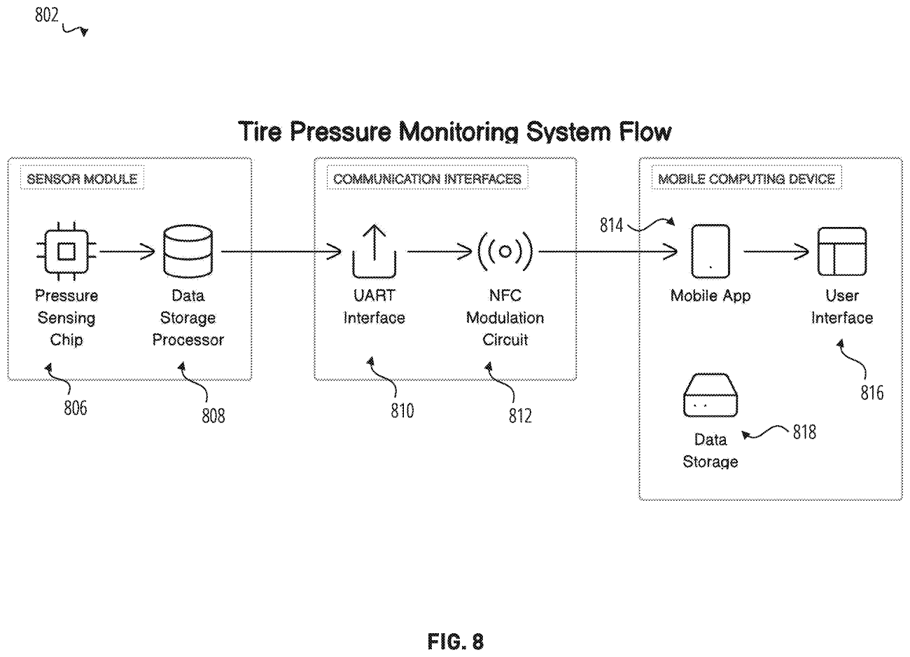

Referring to FIG. 8, a block diagram of a tire pressure monitoring system 802, according to some examples, is presented. A process begins with a pressure-sensing chip 806 of the tire pressure sensor module 104 detecting the tire pressure. The pressure-sensing chip 806 is designed to measure the pressure inside the tubeless tire. In some cases, the pressure-sensing chip 806 may be a piezoresistive pressure sensor, which measures pressure based on the change in electrical resistance that occurs when mechanical strain is applied to the sensor. The pressure-sensing chip 806 can measure pressures in a range of 5 to 60 PSI, making it suitable for monitoring the pressure levels in tubeless bicycle tires, which typically operate at lower pressures compared to automotive tires.

The measured pressure data is then encapsulated into a data packet.. This data packet contains the raw pressure data from the pressure-sensing chip 806, which is then processed by a data storage processor 808. The data storage processor 808 is designed to process the raw pressure data and prepare it for transmission. This processing may involve various operations such as filtering, amplification, or digitization, depending on the specific requirements of the system.

The processing of sensor data is a complex task that involves several operations, each designed to enhance the quality and usability of the data. These operations can vary depending on the specific requirements of the system, but they generally include filtering, amplification, and digitization.

Filtering is an operation that removes unwanted components or features from the sensor data. This may include noise or interference that may distort the data and lead to inaccurate readings. By filtering out these unwanted components, the system can ensure that the sensor data is clean and accurate, enhancing the reliability of the measurements.

Amplification is another operation that can be applied to the sensor data. This operation increases the magnitude of the sensor data, making it easier to analyze and interpret. Amplification can be particularly useful when the sensor data is weak or faint, such as when the tire pressure or sealant level is low. By amplifying the sensor data, the system can ensure that even small changes in tire pressure or sealant level can be detected and monitored.

Digitization is the process of converting the sensor data into a digital format that can be processed by a computer. This operation may be needed for wireless transmission, as the sensor data has to be in a digital format to be encoded into a wireless signal. Digitization also allows for the sensor data to be stored and analyzed using digital tools and algorithms, enhancing the flexibility and capabilities of the system.

By applying these operations, the system 802 can ensure that the sensor data is accurate, readable, and ready for wireless transmission, enabling real-time monitoring of tire pressure and sealant levels.

Once the pressure data has been processed, it is transmitted to a UART (universal asynchronous receiver-transmitter) interface 810. The UART interface 810 serves as a communication interface between the data storage processor and the NFC modulation circuit.

The Universal Asynchronous Receiver-Transmitter (UART) interface 810 plays a role in the wireless transmission of the processed pressure data. The UART interface 810 is specifically designed to encode the processed pressure data into a format that is compatible with wireless transmission protocols. This encoding process involves converting the processed pressure data, which is in a digital format, into a series of signals that can be transmitted wirelessly. These signals represent the binary values of the processed pressure data, allowing the data to be transmitted as a series of high and low signals.

Furthermore, the UART interface 810 also manages the timing of the wireless transmission. It ensures that the signals are transmitted at a consistent rate, which is known as the baud rate. This consistent rate of transmission allows the receiving device to accurately interpret the signals and reconstruct the original pressure data. The UART interface 810 also manages the start and stop bits for each byte of data, which signal the beginning and end of each byte to the receiving device. This ensures that the receiving device can accurately separate each byte of data and correctly interpret the transmitted pressure data.

Overall, the UART interface 810 provides a robust and reliable method for encoding the processed pressure data into a format that can be transmitted wirelessly. This enables the wireless transmission of real-time pressure data from the sensor module to an external device, providing the user with up-to-date information about the tire pressure.

The encoded pressure data is then passed on to the NFC modulation circuit 812. The NFC modulation circuit 812 is responsible for modulating the encoded pressure data onto an NFC signal for wireless transmission. The NFC modulation circuit 812 can use various modulation schemes, such as amplitude shift-keying or phase shift-keying, depending on the specific requirements of the system.

The modulated NFC signal is then transmitted to a mobile computing device application 814. The mobile computing device application 814 can be a software application running on a mobile device, such as a smartphone or tablet. The mobile computing device application 814 is designed to receive the NFC signal, demodulate it to extract the encoded pressure data, and decode the pressure data to obtain the original pressure measurements.

The mobile computing device application 814 then displays the pressure data on a user interface 816. The user interface 816 can be a graphical user interface that presents the pressure data in a readable and understandable format. This can include numerical displays, graphical plots, or other visual representations of the pressure data. The user interface can also provide alerts or notifications if the pressure data indicates that the tire pressure is outside of a specified range.

In addition to displaying the pressure data, the mobile computing device application 814 also manages the storage and retrieval of the tire pressure data. The tire pressure data can be stored in a data storage 818, which can be a memory device or a database. The data storage 818 allows the pressure data to be stored for later retrieval and analysis. This can be useful for tracking the tire pressure over time, identifying trends or patterns, or diagnosing potential issues.

Overall, the tire pressure monitoring system 802 provides a comprehensive solution for wirelessly monitoring the tire pressure in tubeless tires. By integrating a pressure-sensing chip 806, a data storage processor 808, a UART interface 810, an NFC modulation circuit 812, a mobile computing device application 814, and a data storage 818, the system 802 can measure the tire pressure, process the pressure data, transmit the pressure data wirelessly, and display the pressure data to the user in real-time.

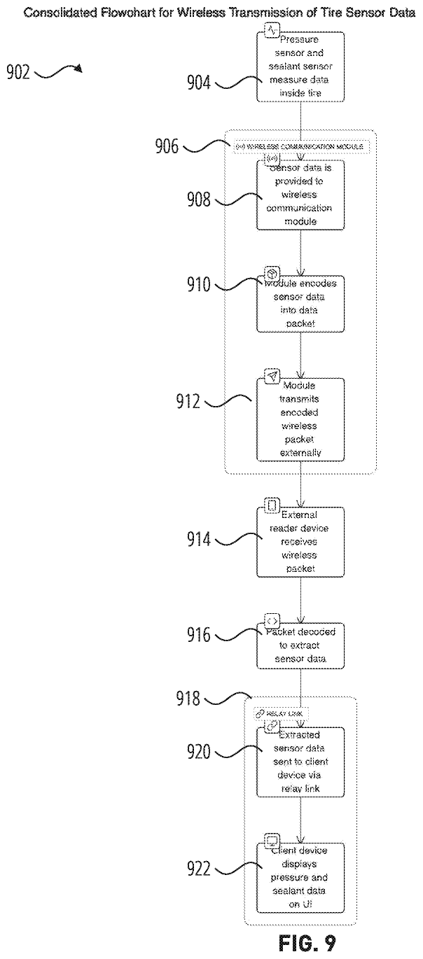

Referring to FIG. 9, a flowchart illustrates a method 902, according to some examples, for the wireless transmission of tire sensor data. The method 902 begins with operation 904, where tire pressure and sealant sensors measure relevant data inside the tire. These sensors, which can be part of the wireless sensor module 102, are designed to detect the pressure and sealant level within the tire. The pressure sensor 114 measures the pressure based on the change in electrical resistance that occurs when mechanical strain is applied to the sensor, while the sealant sensor 116 measures the sealant level based on the conductivity between two or more electrical contacts.

Once the pressure and sealant level data are measured, they are sent to a wireless communication module. This wireless communication module, which can be a near field communication (NFC) transmitter or a Bluetooth transmitter (e.g., NFC reader to Bluetooth relay 106), is configured to receive the sensor data and prepare it for external transmission at operation 910. This preparation may involve various operations such as filtering, amplification, or digitization, depending on the specific requirements of the system.

The wireless communication module then sends the sensor data externally at operation 908 This external transmission can be achieved using various wireless communication technologies, such as NFC or Bluetooth. The choice of communication technology can depend on various factors, such as the range, power consumption, and data rate requirements of the system.

In the next step, operation 910, the raw sensor data is encoded into a data packet. This encoding process transforms the raw sensor data into a format that can be transmitted wirelessly. The encoding process can involve various operations, each designed to enhance the integrity and security of the sensor data during transmission.

One such operation is error correction coding. Error correction coding is a technique used to detect and correct errors that may occur during data transmission. It involves adding extra bits to the data, known as parity bits, which are used to check the accuracy of the data when it is received. If any errors are detected, the error correction code can use the parity bits to correct the errors, ensuring that the received data is accurate and reliable.

Data compression is another operation that can be used during the encoding process. Data compression is a technique used to reduce the size of the data, making it more efficient to transmit. It involves removing redundant or unnecessary information from the data, resulting in a compressed version of the data that requires less bandwidth to transmit. Despite the reduction in size, the compressed data still contains all the information of the original data, ensuring that no information is lost during transmission.

Encryption is a third operation that can be used during the encoding process. Encryption is a technique used to secure the data during transmission, protecting it from unauthorized access or tampering. It involves transforming the data into a coded form, known as ciphertext, which can be decoded back into the original data using a decryption algorithm and a secret decryption key. Only those with the correct decryption can access the original data, ensuring that the data remains secure during transmission.

Once the sensor data has been encoded, it is encapsulated into a wireless packet. This encapsulation process involves packaging the encoded data into a specific format that can be transmitted wirelessly. The wireless packet contains the encoded sensor data, along with other information such as the packet header and footer, which are used to manage the transmission and reception of the packet. Once encapsulated, the wireless packet is ready for external transmission, marking the completion of the encoding and encapsulation process.

Operation 912 transmits the encoded wireless packet externally. This transmission can be achieved using various wireless communication technologies, such as NFC or Bluetooth. The wireless packet is transmitted to an external reader device, which can be a mobile phone or any other device equipped with NFC or Bluetooth capabilities.

An external reader device receives the wireless packet in operation 914. The reader device is designed to receive the wireless packet, demodulate it to extract the encoded sensor data, and decode the sensor data to obtain the original pressure and sealant level measurements.

The decoded sensor data is then extracted in operation 916. This extraction process can involve various operations, such as error correction decoding, data decompression, or decryption, to recover the original sensor data from the encoded sensor data. The extracted sensor data includes the pressure and sealant level measurements taken by the sensors inside the tire.

This extracted sensor information is sent to the client device via a relay link in operation 920. The client device can be a mobile phone or any other device equipped with NFC or Bluetooth capabilities. The client device receives the sensor information and processes it for display.

The process culminates in operation 922, where a client device displays the pressure and sealant data on a user interface. This user interface can be a graphical user interface that presents the pressure and sealant data in a readable and understandable format.

The user interface of the mobile application is designed to present the pressure and sealant data in a user-friendly and intuitive manner. This can include numerical displays, which provide a straightforward and easily understandable representation of the data. For instance, the tire pressure can be displayed as a numerical value in PSI (pounds per square inch), allowing the user to quickly check the current tire pressure at a glance.

Additionally, the user interface can also feature graphical plots, which provide a visual representation of the data over time. These plots can be particularly useful for tracking changes in the tire pressure and sealant level, helping the user to identify trends or patterns. For example, a line graph may be used to plot the tire pressure over time, allowing the user to see how the pressure changes during a ride or over several rides. Similarly, a bar graph may be used to display the sealant level, showing the user how the sealant level has fluctuated over a period of time.

Beyond numerical displays and graphical plots, the user interface can also include other visual representations of the pressure and sealant data. These may include color-coded indicators, gauge-style displays, or even 3D models of the tire showing the distribution of the sealant within the tire. These visual representations can provide a more intuitive understanding of the data, making it easier for the user to interpret and act upon the information.

Furthermore, the user interface is designed to provide alerts or notifications if the pressure or sealant data indicates that the tire pressure or sealant level is outside of a specified range. These alerts can be visual, such as flashing indicators or pop-up messages on the screen, or auditory, such as beeps or alarms. The alerts can also be customized based on the user's preferences, allowing the user to set the threshold values for the tire pressure and sealant level that will trigger an alert. This feature ensures that the user is promptly notified of any potential issues, allowing them to take immediate action to address the problem and maintain the performance and safety of the tire.

In addition to the aforementioned user interface features, the mobile application may also include a historical data section. This section may display past pressure and sealant data, allowing the user to track changes over time and identify any long-term trends or patterns. The historical data may be presented in various formats, such as tables, line graphs, or bar charts, providing a comprehensive overview of the tire's performance history.

The user interface may also feature an interactive 3D model of the tire, which may provide a more detailed and intuitive representation of the sealant distribution within the tire. The user may rotate and zoom in on the 3D model to examine specific areas of the tire, enhancing their understanding of the sealant level and distribution.

Furthermore, the user interface may include a predictive alert system. This system may analyze the historical pressure and sealant data to predict future trends and provide early warnings if the pressure or sealant level is predicted to fall outside of the specified range. This predictive alert system may help the user to proactively manage the tire's performance and safety, preventing potential issues before they occur.

The user interface may also include a tutorial or guide section. This section may provide instructions and tips on how to maintain the tire pressure and sealant level, enhancing the user's understanding and management of the tire's performance. The guide section may include video tutorials, step-by-step instructions, or interactive simulations, providing a comprehensive and user-friendly resource for tire maintenance.

Additionally, the user interface may include a settings section. This section may allow the user to customize various aspects of the application, such as the alert thresholds, display preferences, or notification settings. This customization may enhance the user's experience and interaction with the application, allowing them to tailor the application to their specific preferences and requirements.

The user interface may also include a feedback section. This section may allow the user to provide feedback on the application, such as reporting bugs, suggesting improvements, or rating the application. This feedback may be valuable for the continuous improvement and development of the application, ensuring that it meets the user's expectations and requirements.

Moreover, the user interface may include a troubleshooting section. This section may provide solutions and advice for common issues or problems that the user may encounter with the tire or the application. This troubleshooting section may enhance the user's experience and satisfaction with the application, providing a valuable resource for resolving issues and ensuring the smooth operation of the tire and the application.

The wireless sensor module 102, in some examples, implements data processing algorithms to analyze sensor measurements and provide meaningful insights to users. The processing begins with the analysis of sealant level data, where a processing chip employs both static and dynamic threshold comparisons to evaluate conductivity measurements between the electrical contacts 126.

This dual-analysis approach provides a comprehensive view of the sealant condition within the tire 204. The static analysis establishes baseline measurements by comparing absolute conductivity values against predetermined thresholds that indicate critical sealant levels. These thresholds are calibrated to account for variations in sealant conductivity and environmental conditions.

A dynamic analysis component examines the temporal changes in conductivity during tire rotation, providing insights into sealant distribution patterns. This process begins with establishing a baseline conductivity measurement at the tire's resting position, followed by sequential measurements taken during incremental tire rotation. The system specifically monitors for rapid conductivity changes that indicate sealant movement, mapping these inflection points to determine actual sealant depth. To enhance measurement accuracy, the system may correlate these readings with data from the humidity sensor 122, providing an additional validation mechanism for sealant level determination.

Pressure analysis within the system involves processing of data from the pressure sensor 114. The processing algorithm validates pressure readings within the operational range of 5-60 PSI while incorporating temperature compensation using data from the temperature sensor 124. This temperature compensation ensures accurate pressure readings across varying environmental conditions. The system maintains a historical record of pressure measurements, enabling trend analysis that can identify gradual pressure changes that might otherwise go unnoticed.

An alert generation system may process data streams from multiple sensors to provide timely and relevant notifications to users. The sealant level alert system continuously monitors conductivity measurements, triggering alerts when sealant levels fall below critical thresholds. Similarly, the tire pressure alert system processes pressure sensor data to identify both immediate pressure issues and concerning trends over time. These alerts are designed to be proactive rather than reactive, helping users maintain optimal tire conditions.

Data integration represents an aspect of the system's processing capabilities. The NFC processor 118 serves as the central hub for integrating data from multiple sensors, including the pressure sensor 114, sealant sensor 116, humidity sensor 122, and temperature sensor 124. This integrated approach allows for comprehensive tire health assessment by correlating data from multiple sources. The processed data undergoes encoding into NDEF message packets for efficient transmission to the mobile phone 110 via the NFC reader to Bluetooth relay 106, where the application 112 presents the analyzed data in an intuitive format.

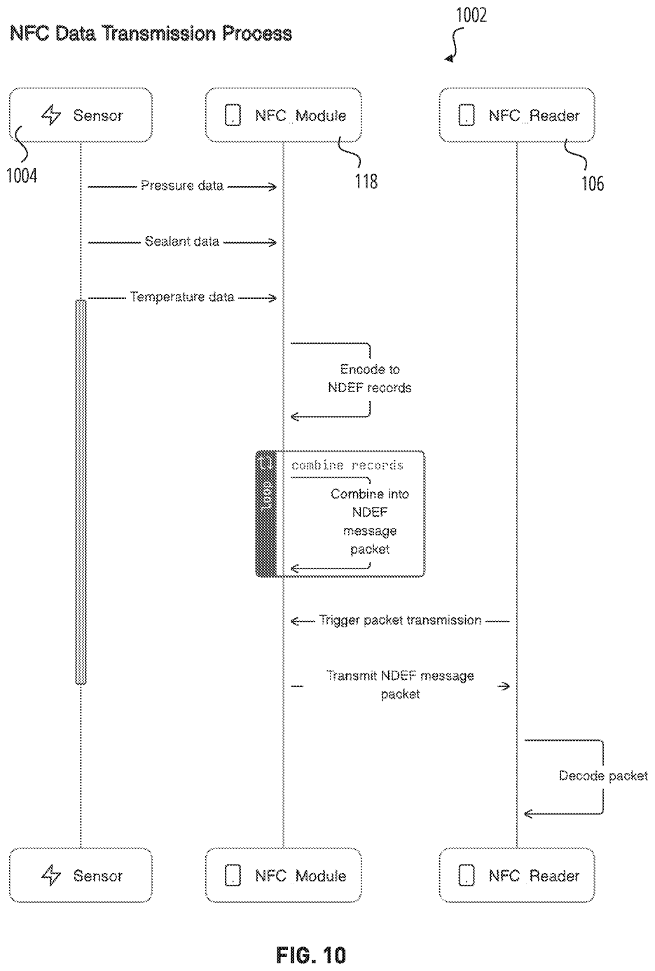

Referring to FIG. 10, a sequence diagram of an NFC Data Transmission method 1002, according to some examples, is illustrated, outlining the operations involved in transmitting data from a sensor to an NFC reader. The process begins with the sensors 1004, which include a pressure sensor, a sealant sensor, a temperature sensor, or any other type of sensor suitable for monitoring conditions inside a tubeless tire. The sensors 1004 measure the relevant parameter, such as pressure, sealant level, or temperature, and send this data to the NFC processor 118.

The NFC processor 118, which can be part of the wireless sensor module 102, is responsible for processing the sensor data and preparing it for wireless transmission. The NFC processor 118 encodes the sensor data into NDEF (NFC Data Exchange Format) records. NDEF is a standard data format that is used for communication between NFC devices. The encoded sensor data is then combined into an NDEF message packet. This packet encapsulates the sensor data in a format that can be transmitted wirelessly and understood by the NFC reader to Bluetooth relay 106.

Once the NDEF message packet has been prepared, the NFC processor 118 transmits the packet to the NFC reader to Bluetooth relay 106. This transmission is achieved using NFC technology, which allows for short-range wireless communication between devices. The NFC reader to Bluetooth relay 106 receives the NDEF message packet and decodes it to extract the sensor data.

The decoding process involves reversing the encoding process performed by the NFC processor 118. The NDEF message packet is unpacked to extract the NDEF records, and the sensor data is then decoded from the NDEF records. This decoded sensor data includes the pressure, sealant level, and temperature measurements taken by the sensors 1004. This data can then be retransmitted from the NFC reader to Bluetooth relay 106 to the mobile phone 110 which can processed and displayed on the mobile phone 110 using the application 112, providing the user with real-time information about the conditions inside the tubeless tire.

This NFC Data Transmission method 1002 provides a comprehensive solution for wirelessly monitoring the pressure, sealant level, and temperature in tubeless tires. By integrating sensors 1004, NFC processor 118, NFC reader to Bluetooth relay 106, and a mobile phone 110 the system can measure the relevant parameters, process the sensor data, transmit the sensor data wirelessly, and display the sensor data to the user in real-time.

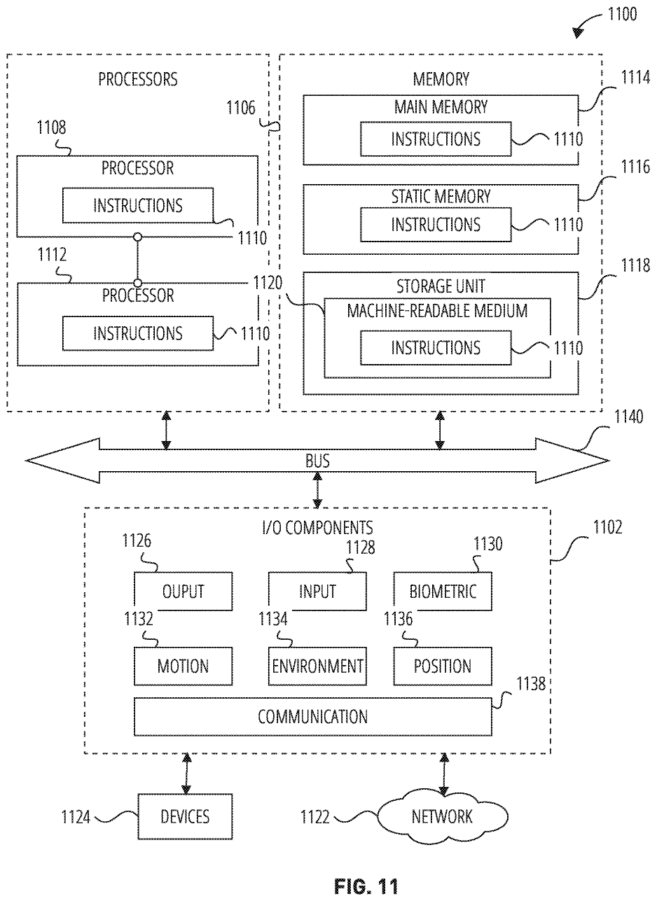

FIG. 11 is a diagrammatic representation of machine 1100 within which instructions 1110 (e.g., software, a program, an application, an applet, an app, or other executable code) for causing the machine 1100 to perform any one or more of the methodologies discussed herein may be executed. For example, the instructions 1110 may cause the machine 1100 to execute the wireless tire monitoring methods described herein.

The instructions 1110 transform the general, non-programmed machine into a particular machine 1100 programmed to carry out the tire pressure and sealant monitoring functions in the manner described. The machine 1100 may operate as a standalone device or be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, the wireless sensor module 102, mobile phone 110 running application 112, or any machine capable of executing the instructions 1110 that specify actions to be taken. Further, while a single machine 1100 is illustrated, the term “machine” may include a collection of machines that individually or jointly execute the instructions 1110 to perform any one or more of the tire monitoring methodologies discussed herein.

The machine 1100 includes processors 1104, memory 1106, and I/O components 1102, which may be configured to communicate via a bus 1140. The processors 1104 may include specialized processors for tire monitoring such as the NFC processor 118 and pressure sensing chip, as well as general purpose processors like CPUs, GPUs, DSPs, ASICs, RFICs, TPUs, NPUs, VPUs, MLAs, FPGAs, and other processors.

The processors may execute instructions 1110 for monitoring tire pressure, sealant levels, temperature and humidity.

The memory 1106 includes main memory 1114, static memory 1116, and storage unit 1118, accessible to the processors 1104 via bus 1140. These memories may store the instructions 1110 embodying the tire monitoring methodologies described herein. The instructions may reside in any of these memories during execution.

The I/O components 1102 may for example include:
Output components 1126: Displays for showing tire pressure and sealant data, speakers for alerts, haptic components for notifications
Input components 1128: Touch screens and buttons for user interaction with the tire monitoring application
Environmental components 1134: Pressure sensors, humidity sensors, and temperature sensors for monitoring tire conditions
Communication components 1138: NFC components for wireless data transmission between the sensor module and mobile device, Bluetooth components for extended range communication

The communication components 1138 enable may wireless transmission of tire sensor data using NFC and Bluetooth protocols. They handle the encoding and transmission of pressure, sealant level, temperature and humidity data from the wireless sensor module to the mobile application.

The various memories store instructions and data structures for implementing the tire monitoring system. These instructions, when executed by the processors, enable real-time monitoring of tire conditions and alert users when pressure or sealant levels are outside acceptable ranges.

The instructions 1110 may be transmitted between devices using NFC, Bluetooth or other protocols via the communication components 1138. This allows tire sensor data to be shared between the wireless sensor module and mobile application.

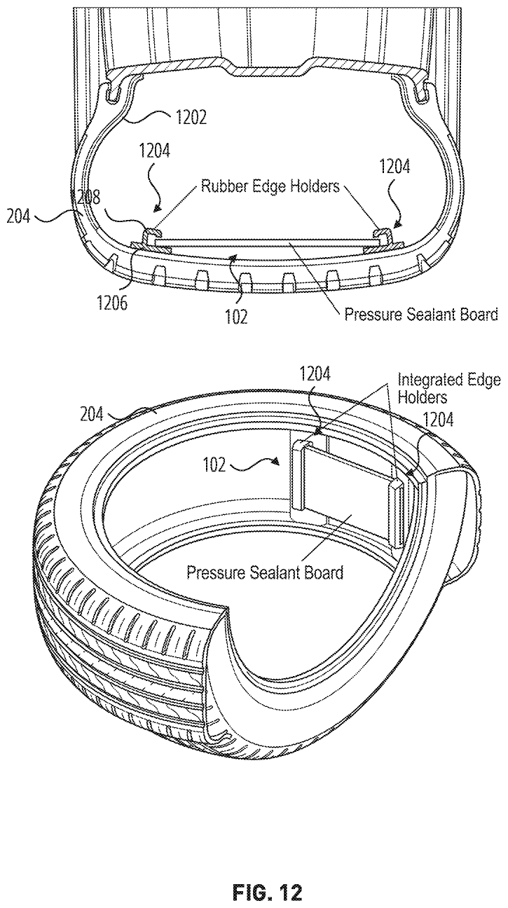

FIG. 12 is a view illustrating a wireless sensor module 102 mechanically retained against an interior surface of a tubeless tire by flexible corner or edge holders, according to some examples.

Referring to FIG. 12, the wireless sensor module 102 is positioned against an interior surface 1202 of a tubeless tire 204. One or more flexible holders 1204 engage respective portions of the wireless sensor module 102 to retain the wireless sensor module 102 against the interior surface 1202.

Each flexible holder 1204 may be formed from rubber or another flexible material that permits insertion and retention of a sensor board. The wireless sensor module 102 may constitute the sensor board received by the flexible holders 1204.

Each flexible holder 1204 includes a base portion 1206 positioned at the interior surface 1202 and a retaining portion 1208 extending over a peripheral portion of the wireless sensor module 102. The base portion 1206 and the retaining portion 1208 define a receiving space configured to receive an edge portion or a corner portion of the wireless sensor module 102. The retaining portion 1208 overlaps the received edge portion or corner portion and restricts movement of the wireless sensor module 102 away from the interior surface 1202.

The flexible holder 1204 may define an insertion opening through which the edge portion or corner portion is inserted into the receiving space. During insertion, the retaining portion 1208 may elastically deform away from the interior surface 1202 to increase a dimension of the insertion opening. After the edge or corner portion enters the receiving space, the retaining portion 1208 may return toward an undeformed position. The retaining portion 1208 may retain the wireless sensor module 102 through elastic force, friction, geometric interference, or a combination thereof.

In some examples, multiple flexible holders 1204 are arranged around a perimeter of the wireless sensor module 102. A pair of flexible holders 1204 may engage opposing edge portions. In other examples, respective flexible holders 1204 may engage two, three, or four corner portions. A flexible holder 1204 may engage only an edge portion, only a corner portion, or both an edge portion and a corner portion. The number, dimensions, and positions of the flexible holders 1204 may be selected based on the dimensions and shape of the wireless sensor module 102.

The flexible holders 1204 may be integrally formed with the tubeless tire 204 during manufacture of the tubeless tire 204. For example, the flexible holders 1204 may be molded from an elastomeric tire material at the interior surface 1202. Alternatively, the flexible holders 1204 may be formed separately and subsequently secured to the interior surface 1202 using an adhesive, vulcanization, thermal bonding, chemical bonding, or another attachment process compatible with the material of the tubeless tire 204. The flexible holders 1204 may be formed from rubber, silicone, an elastomer, a flexible polymer, or another material capable of deforming during insertion of the wireless sensor module 102 and retaining the wireless sensor module 102 after insertion.

The flexible holders 1204 mechanically retain the wireless sensor module 102 against the interior surface 1202. The mechanical retention may be used without an adhesive bond between the wireless sensor module 102 and the interior surface 1202. In other examples, an adhesive layer may be positioned between the wireless sensor module 102 and the interior surface 1202 in addition to the flexible holders 1204. In that arrangement, the flexible holders 1204 resist separation or displacement of the wireless sensor module 102 if the adhesive bond weakens during use.

A central region of the wireless sensor module 102 may remain exposed to an interior cavity of the tubeless tire 204 when the peripheral edge portions or corner portions are received by the flexible holders 1204. The central region may include or provide access to one or more sensing components carried by the wireless sensor module 102. For example, the wireless sensor module 102 may include the pressure sensor 114, sealant sensor 116, NFC processor 118, NFC antenna 120, humidity sensor 122, temperature sensor 124, and electrical contacts 126 described with reference to FIG. 1.

The flexible holders 1204 may be positioned so that they do not cover the electrical contacts 126 of the sealant sensor 116. The electrical contacts 126 may therefore remain exposed to tire sealant 210 within the tubeless tire 204. Similarly, an inlet or sensing surface of the pressure sensor 114 may remain exposed to the interior cavity so that the pressure sensor 114 can generate pressure data indicative of pressure within the tubeless tire 204.

The flexible holders 1204 may also be positioned so that they do not cover the NFC antenna 120 or otherwise separate the NFC antenna 120 from an external reader by additional conductive material. The wireless sensor module 102 may therefore receive electromagnetic energy from an external NFC reader, use the received energy to power one or more sensing operations, and transmit sensor data to the external NFC reader as described for the wireless monitoring system of FIGS. 1-10.

The receiving space may have a thickness corresponding to a thickness of the wireless sensor module 102. In some examples, the receiving space is smaller than the corresponding edge portion in an undeformed state so that the flexible holder 1204 applies a compressive force to the edge portion. The retaining portion 1208 may include a curved, tapered, hooked, or overhanging profile that facilitates insertion of the wireless sensor module 102 while resisting withdrawal from the receiving space.

The flexible holders 1204 may permit removal and replacement of the wireless sensor module 102. A user may deform one or more retaining portions 1208 to release corresponding edge portions or corner portions and then withdraw the wireless sensor module 102. A replacement wireless sensor module may subsequently be inserted into the same flexible holders 1204. This configuration permits the tubeless tire 204 and the flexible holders 1204 to remain in service when the wireless sensor module 102 is removed for inspection, replacement, or servicing

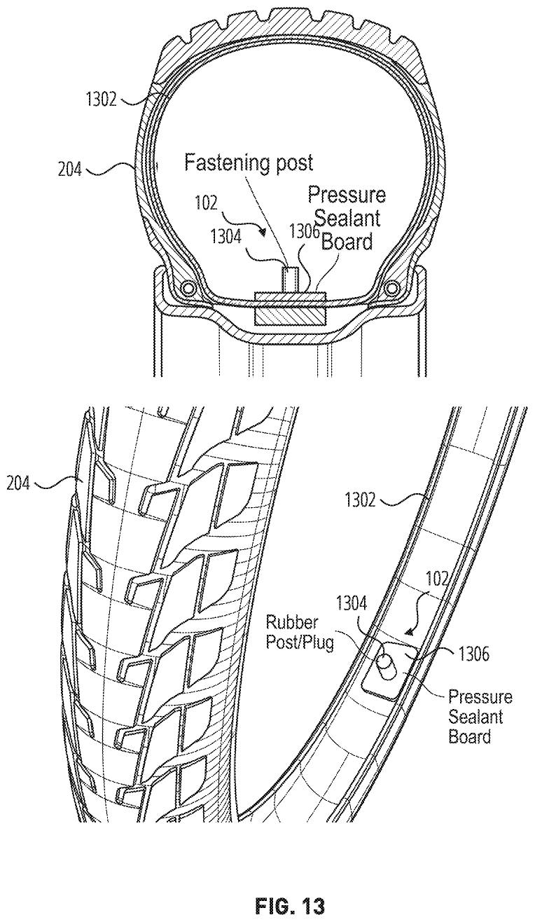

FIG. 13 is a view illustrating a wireless sensor module retained against an interior surface of a tubeless tire by a fastening post, including an integrally formed fastening-post configuration and an aftermarket rubber post or plug configuration, according to some examples.

Referring to FIG. 13, a wireless sensor module 102 is positioned within a tubeless tire 204 and mechanically retained against an interior surface 1302 of the tubeless tire 204 by a fastening post 1304. The wireless sensor module 102 may comprise a pressure-and-sealant sensor board carrying the pressure sensor 114, sealant sensor 116, NFC processor 118, NFC antenna 120, humidity sensor 122, temperature sensor 124, and electrical contacts 126 described with reference to FIG. 1.

The wireless sensor module 102 includes a support structure 1306 defining an aperture. The aperture may be centrally located within the support structure 1306. The fastening post 1304 extends from the interior surface 1302 and through the aperture to retain the support structure 1306 against the interior surface 1302.

The fastening post 1304 includes a proximal portion disposed adjacent to or joined with the interior surface 1302 and a distal portion positioned on a side of the support structure 1306 opposite the interior surface 1302 after installation. The distal portion may define a retaining head having a transverse dimension greater than a corresponding transverse dimension of the aperture. The retaining head thereby restricts withdrawal of the fastening post 1304 through the aperture and restricts movement of the wireless sensor module 102 away from the interior surface 1302.

In the upper view of FIG. 13, the fastening post 1304 is positioned at an interior bottom portion of the tubeless tire 204. The fastening post 1304 may be integrally formed with the tubeless tire 204 during manufacture of the tubeless tire 204. For example, the fastening post 1304 may be molded from rubber or another elastomeric material together with an inner liner or other portion of the tubeless tire 204. The integral connection between the proximal portion and the interior surface 1302 anchors the fastening post 1304 to the tubeless tire 204.

The support structure 1306 may be installed by aligning the aperture with the fastening post 1304 and moving the support structure 1306 along the fastening post 1304 toward the interior surface 1302. The fastening post 1304 or the retaining head may elastically deform as the retaining head passes through the aperture. After passing through the aperture, the retaining head may return toward an undeformed configuration and retain the support structure 1306 against the interior surface 1302.

The fastening post 1304 may be tapered to permit the fastening post 1304 to be pushed through the aperture. A tapered surface may extend toward the distal portion and guide the retaining head into and through the aperture. The fastening post 1304 may alternatively or additionally be stretched during installation. Stretching the fastening post 1304 may reduce the transverse dimension of the retaining head sufficiently to permit the retaining head to pass through the aperture. Releasing the fastening post 1304 may allow the fastening post material to expand and retain the wireless sensor module 102.

A retainer clip may optionally engage the distal portion after the fastening post 1304 has been inserted through the aperture. The retainer clip may have an opening through which the distal portion extends and may bear against the support structure 1306. The retainer clip may supplement retention provided by the retaining head. The retainer clip may be removable to permit removal or replacement of the wireless sensor module 102.

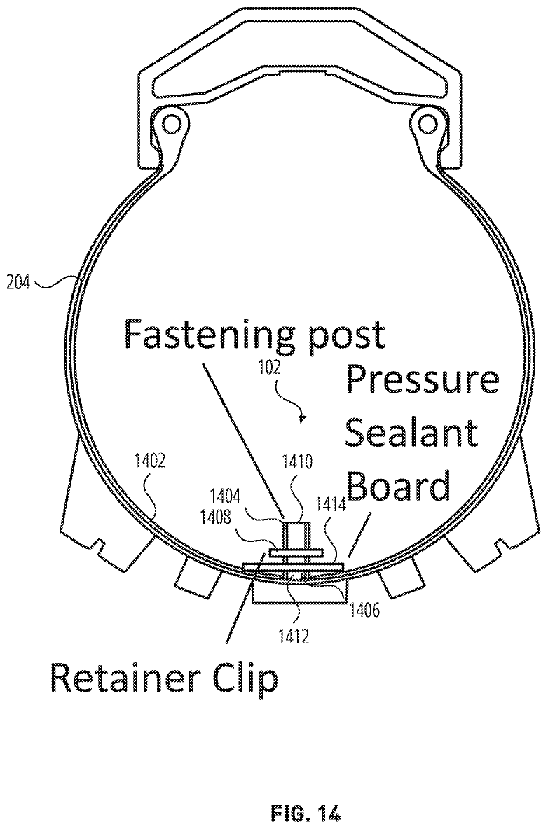

FIG. 14 is a cross-sectional view illustrating a wireless sensor module mechanically retained against an interior surface of a tubeless tire by a fastening post and a retainer clip, according to some examples.

Referring to FIG. 14, the wireless sensor module 102 includes a support structure 1414 positioned against an interior surface 1402 of the tubeless tire 204. A fastening post 1404, distinct from the support structure 1414, engages an aperture 1406 extending through the support structure 1414. The aperture 1406 provides a retention feature by which the fastening post 1404 mechanically retains the wireless sensor module 102 against the interior surface 1402.

The fastening post 1404 includes a proximal portion 1410 disposed at the interior surface 1402 and a distal portion 1412 disposed on a side of the support structure 1414 opposite the interior surface 1402. The distal portion 1412 has a transverse dimension greater than a transverse dimension of the aperture 1406 and thereby restricts withdrawal of the fastening post 1404 through the aperture 1406.

A retainer clip 1408 engages the distal portion 1412 on the side of the support structure 1414 opposite the interior surface 1402. The retainer clip 1408 may bear against the support structure 1414 to supplement the mechanical retention provided by the distal portion 1412. The retainer clip 1408 may be removable to permit installation, removal, or replacement of the wireless sensor module 102.

The fastening post 1404 may be integrally formed with the tubeless tire 204 or separately attached to the interior surface 1402. The fastening post 1404 may be tapered or elastically deformable as described with reference to FIG. 13 to permit the distal portion 1412 to pass through the aperture 1406 during installation. The fastening post 1404 and the retainer clip 1408 may retain the wireless sensor module 102 without an adhesive bond or may supplement an adhesive bond between the support structure 1414 and the interior surface 1402.

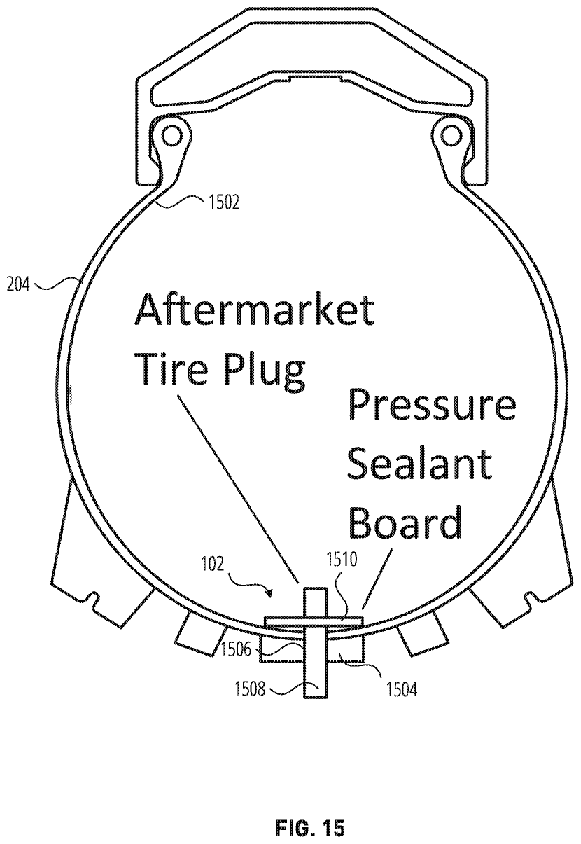

FIG. 15 is a cross-sectional view illustrating a wireless sensor module mechanically retained within a tubeless tire by an aftermarket tire plug, according to some examples.

Referring to FIG. 15, the wireless sensor module 102 includes a support structure 1510 positioned against an interior surface 1502 of the tubeless tire 204. An aftermarket tire plug 1508 is received within a hole 1506 extending through a carcass 1504 of the tubeless tire 204.

The aftermarket tire plug 1508 includes a first portion received in sealing engagement within the hole 1506 and a second portion extending through an aperture in the support structure 1510. A distal end of the second portion has a transverse dimension greater than a transverse dimension of the aperture, thereby retaining the wireless sensor module 102 against the interior surface 1502.

The aftermarket tire plug 1508 may comprise rubber or another elastically deformable material. The sealing engagement of the first portion may seal the hole 1506 against loss of air or tire sealant independently of the retention of the wireless sensor module 102 by the second portion and the distal end. The aftermarket tire plug 1508 may be installed in an existing tubeless tire 204 using a tire-plug installation process.

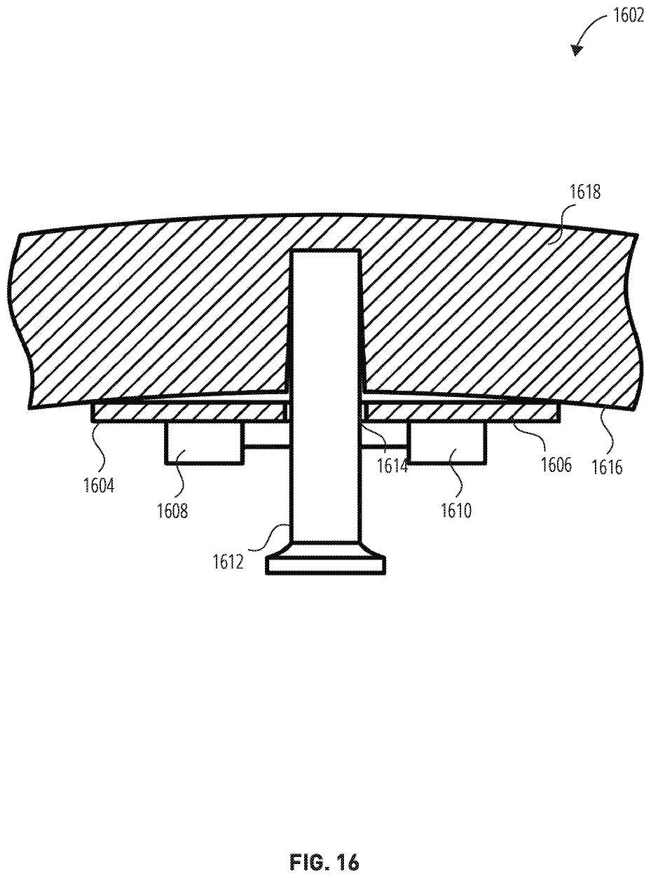

Referring to FIG. 16, a cross-sectional view of a tire pressure sensor assembly 1602 is illustrated, according to some examples. The tire pressure sensor assembly 1602 includes a module 1604 and a fastening structure 1612. The module 1604 comprises a support structure 1606, a pressure sensor 1608 carried by the support structure 1606, and a wireless transmitter 1610 carried by the support structure 1606. The pressure sensor 1608 is configured to generate pressure data indicative of a pressure within a tubeless tire 1618, and the wireless transmitter 1610 is configured to wirelessly transmit the pressure data. In some examples, the pressure sensor 1608 and the wireless transmitter 1610 may be implemented using components corresponding to the pressure sensor 114 and the NFC processor 118 and NFC antenna 120 described above with reference to FIG. 1, although other pressure-sensing and wireless-transmission components may be used.

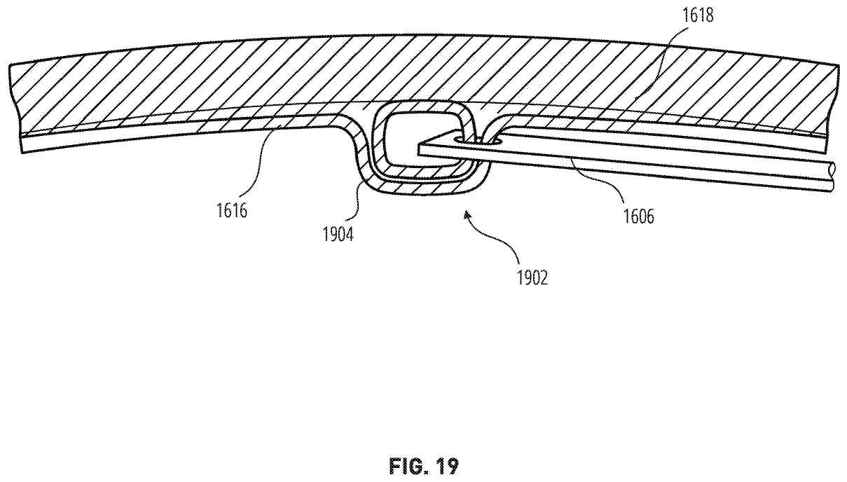

The support structure 1606 defines a retention feature 1614. In the example illustrated in FIG. 16, the retention feature 1614 comprises an aperture extending through the support structure 1606, although other retention-feature geometries are described below with reference to FIG. 19. The fastening structure 1612 is distinct from the support structure 1606 and engages the retention feature 1614 to mechanically retain the module 1604 against an interior surface 1616 of the tubeless tire 1618. In contrast to the adhesive-based mounting described above with reference to FIG. 2, the fastening structure 1612 retains the module 1604 against the interior surface 1616 through a mechanical engagement with the retention feature 1614, rather than, or in addition to, an adhesive bond between the module 1604 and the interior surface 1616.

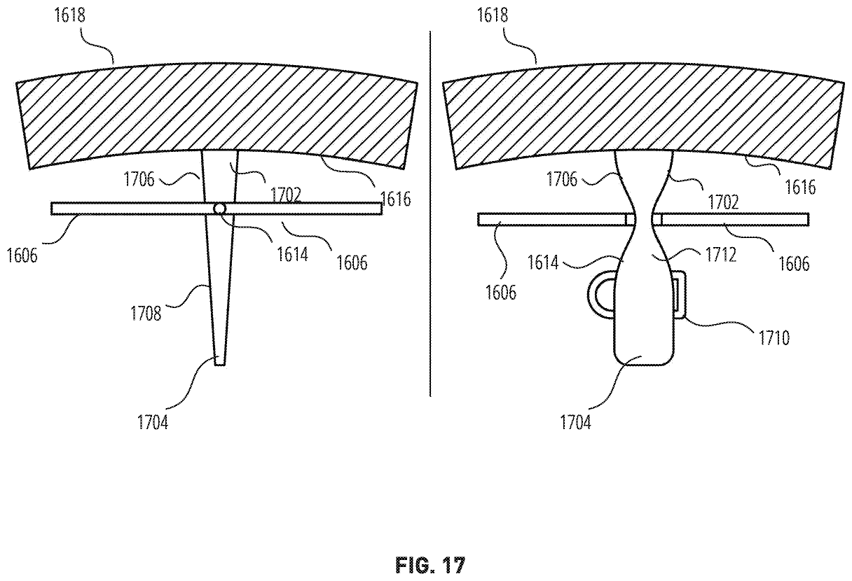

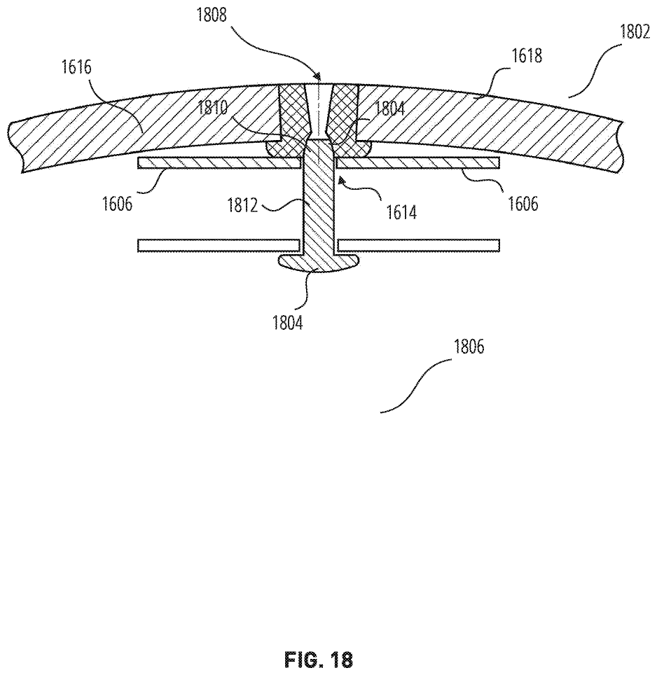

The fastening structure 1612 illustrated in FIG. 16 represents a genus of retention structures encompassing several disclosed species. As described in greater detail with reference to FIG. 17, the fastening structure 1612 may comprise a post extending through the aperture of the retention feature 1614, the post having a proximal portion fixed relative to the interior surface 1616 and a distal portion with a transverse dimension greater than a transverse dimension of the aperture, such that the distal portion resists withdrawal of the post back through the aperture once inserted. As described with reference to FIG. 18, the fastening structure 1612 may comprise a plug body received in sealing engagement within a hole formed through a carcass of the tubeless tire 1618, a portion of which extends through the retention feature 1614 to retain the module 1604. As described with reference to FIG. 19, the fastening structure 1612 may comprise a flexible pocket that receives and retains an edge of the support structure 1606, in which case the support structure's retention feature comprises the edge itself rather than an aperture. Each of these species mechanically engages a retention feature of the support structure 1606 to retain the module 1604 against the interior surface 1616 without relying on an adhesive bond as the means of attachment.

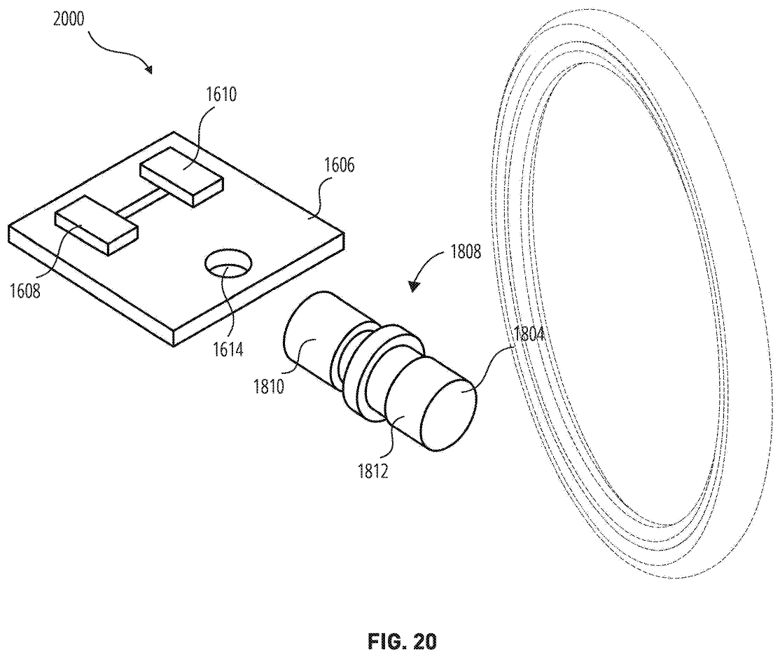

In some examples, the fastening structure 1612 may be formed integrally with the interior surface 1616 of the tubeless tire 1618 during manufacture of the tubeless tire 1618, allowing a tire manufacturer to mold a retention structure into the tire and install the module 1604 at a later time, including at the point of sale. In other examples, the fastening structure 1612 may be added to an already-manufactured tubeless tire 1618 as part of an aftermarket installation, as described in greater detail with reference to FIG. 20. The module 1604 may further comprise additional sensors, such as a sealant sensor, a humidity sensor, or a temperature sensor, carried by the support structure 1606 in the manner described above with reference to FIG. 1, and the wireless transmitter 1610 may comprise a near field communication processor and antenna configured to harvest energy from near field communications to power the pressure sensor 1608 and the wireless transmitter 1610, also as described above with reference to FIG. 1.

Referring to FIG. 17, two species of the post-type fastening structure 1612 (FIG. 16) are illustrated in cross-section, according to some examples. In both species, a post 1702 extends through the retention feature 1614 (an aperture) of the support structure 1606, the post 1702 having a proximal portion 1706 disposed toward the interior surface 1616 of the tubeless tire 1618 and a distal portion 1704 disposed on a side of the support structure 1606 opposite the interior surface 1616.

The post 1702 tapers from the proximal portion 1706 to the distal portion 1704, the taper 1708 configured to permit the distal portion 1704 to be pushed through the retention feature 1614 during installation of the support structure 1606 onto the post 1702. The distal portion 1704 may have a transverse dimension greater or less than a transverse dimension of the retention feature 1614, so that once the distal portion 1704 has passed through the retention feature 1614, the distal portion 1704 resists being drawn back through the retention feature 1614, retaining the support structure 1606 against the interior surface 1616.

The post 1702 may also comprises an elastically deformable material 1712, shown in a stretched state (narrower) during insertion through the retention feature 1614, and in a relaxed state (wider) after insertion, in which the distal portion 1704 returns to a transverse dimension greater than the transverse dimension of the retention feature 1614. FIG. 17 further illustrates a retainer clip 1710 engaging the distal portion 1704 on the side of the support structure 1606 opposite the interior surface 1616, providing additional positive retention of the support structure 1606 on the post 1702. In some examples, the post 1702 illustrated in FIG. 17 is integrally formed with the interior surface 1616 of the tubeless tire 1618, such as by molding the post 1702 into the tire during manufacture.

Referring to FIG. 18, a cross-sectional view illustrates a plug body 1808 providing the fastening structure 1612 (FIG. 16) for a module 1604 (FIG. 16), according to some examples. A carcass 1802 of the tubeless tire 1618 defines a hole 1806 extending through the carcass 1802, and the plug body 1808 comprises a first portion 1810 sized for insertion into and sealing engagement with the hole 1806. The sealing engagement of the first portion 1810 within the hole 1806 seals the hole 1806 against loss of tire sealant through the hole 1806.

The plug body 1808 further comprises a second portion 1812 extending from the first portion 1810 to a distal end 1804. The retention feature 1614 of the support structure 1606 comprises an aperture through which the second portion 1812 extends, the aperture having a transverse dimension smaller than a transverse dimension of the distal end 1804. Because the distal end 1804 is wider than the retention feature 1614, the second portion 1812 of the plug body 1808 may be passed through the retention feature 1614 until the distal end 1804 is disposed on a side of the support structure 1606 opposite the first portion 1810 and opposite the interior surface 1616 of the tubeless tire 1618, at which point the distal end 1804 resists being drawn back through the retention feature 1614, retaining the module 1604 against the interior surface 1616.

As illustrated in FIG. 18, the sealing engagement of the first portion 1810 within the hole 1806 and the mechanical retention of the module 1604 by the second portion 1812 and distal end 1804 of the plug body 1808 are achieved independently of one another: the first portion 1810 seals the hole 1806 through the carcass 1802 regardless of whether the second portion 1812 is engaged with the retention feature 1614, and the second portion 1812 and distal end 1804 retain the module 1604 against the interior surface 1616 regardless of the sealing function performed by the first portion 1810. The plug body 1808 thereby performs two functions using a single installed component: sealing an installation hole 1806 formed through the carcass 1802, of the kind that might otherwise be formed for a puncture-repair plug, and anchoring the module 1604 against the interior surface 1616 without an adhesive bond.

In some examples, the plug body 1808 comprises an elastically deformable material, such as a rubber or rubber-like material of the kind used in aftermarket tubeless tire puncture-repair plugs, allowing the plug body 1808 to be installed into the hole 1806 from the interior of the tubeless tire 1618 and trimmed or finished at the tread-facing side of the carcass 1802 as needed. Installing the plug body 1808 in this manner allows the fastening structure 1612 to be added to an already-manufactured tubeless tire 1618, such as at a bike shop or other aftermarket installation setting, without requiring the tire manufacturer to have molded in a dedicated post or pocket structure. The module 1604 retained by the plug body 1808 may include the pressure sensor 1608, the wireless transmitter 1610, and any of the additional sensors described above with reference to FIG. 16, including a sealant sensor, humidity sensor, or temperature sensor.

Referring to FIG. 19, a view illustrates a flexible pocket 1902 providing the fastening structure 1612 (FIG. 16) for a module 1604 (FIG. 16), according to some examples. In this species, the retention feature of the support structure 1606 comprises an edge 1904 of the support structure 1606, rather than an aperture as in the post and plug species described above with reference to FIGS. 13 and 14.

The flexible pocket 1902 is formed of a flexible material, such as rubber or another elastomeric material, positioned at the interior surface 1616 of the tubeless tire 1618. The flexible pocket 1902 receives the edge 1904 of the support structure 1606 by insertion, and retains the edge 1904 against the interior surface 1616 by friction, flexure, or a combination thereof, without an aperture in the support structure 1606 or a post or plug engaging such an aperture. In some examples, the flexible pocket 1902 is shaped to receive a corner of the support structure 1606 defined by two intersecting edge 1904, and multiple flexible pocket 1902 may be positioned to engage multiple edges or corners of the same support structure 1606, distributing the retention of the module 1604 across more than one location on the support structure 1606.

The flexible pocket 1902 illustrated in FIG. 19 differs structurally from a mesh or porous retention structure in that the flexible pocket 1902 need not be permeable to tire sealant. Because tire sealant retained within the interstices of a mesh or porous structure can foul electrical contacts of a sealant sensor carried by the support structure 1606, the flexible pocket 1902 in some examples is instead formed as a substantially solid, non-porous structure that engages the edge 1904 without necessarily allowing sealant to flow through the flexible pocket 1902 itself.

Referring to FIG. 20, a view illustrates a tire pressure sensing kit 2000 prior to installation into a tubeless tire, according to some examples. The tire pressure sensing kit 2000 comprises the plug body 1808 (FIG. 18) and the module 1604 (FIG. 16), shown as separate, unassembled components. The plug body 1808 comprises the first portion 1810 sized for insertion into and sealing engagement with a hole formed through a carcass of a tubeless tire, and the second portion 1812 extending from the first portion 1810 to the distal end 1804, the distal end 1804 having a transverse dimension larger than a transverse dimension of the retention feature 1614 (an aperture) of the support structure 1606 of the module 1604.

The module 1604 of the tire pressure sensing kit 2000 comprises the support structure 1606, the pressure sensor 1608 carried by the support structure 1606 and configured to generate pressure data indicative of a pressure within a tubeless tire, and the wireless transmitter 1610 carried by the support structure 1606 and configured to wirelessly transmit the pressure data.

The tire pressure sensing kit 2000 is configured to be installed into a tubeless tire by inserting the first portion 1810 of the plug body 1808 into a hole formed through the carcass of the tubeless tire to form the sealing engagement described above with reference to FIG. 18, and passing the second portion 1812 of the plug body 1808 through the retention feature 1614 of the support structure 1606 until the distal end 1804 is disposed on the side of the support structure 1606 opposite the first portion 1810. Because the tire pressure sensing kit 2000 comprises the plug body 1808 and the module 1604 as a self-contained set of components, the tire pressure sensing kit 2000 may be manufactured, sold, and installed as a distinct commercial article, such as through a bike shop or other aftermarket retailer, independently of the tubeless tire into which it is ultimately installed and independently of whether a tire manufacturer molds in a dedicated post or pocket structure for the module 1604.

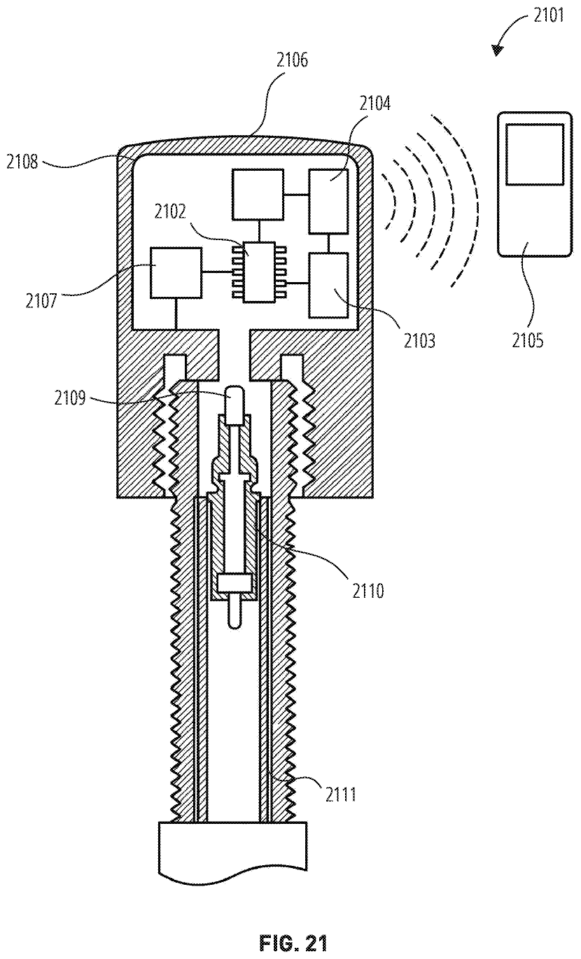

Referring to FIG. 21, a cross-sectional view illustrates a tire pressure sensing device 2101, according to some examples. The tire pressure sensing device 2101 comprises a cap body 2106 configured to thread onto a valve stem 2111 of a tire. A pin 2109 extends from the cap body 2106 and is positioned to depress a valve core 2110 of the valve stem 2111 when the cap body 2106 is threaded onto the valve stem 2111, thereby placing an interior of the tire in fluid communication with the cap body 2106. Depressing the valve core 2110 in this manner allows the pressure sensor 2108 and the humidity sensor 2107, both carried by the cap body 2106, to be exposed to conditions within the interior of the tire while the cap body 2106 remains threaded onto the valve stem 2111 at a location external to the tire.

The pressure sensor 2108 is configured to generate pressure data indicative of a pressure within the tire, and may be implemented, for example, using a pressure sensor of the kind described above with reference to FIG. 1. The humidity sensor 2107 is configured to generate a first humidity reading upon threading of the cap body 2106 onto the valve stem 2111, and to generate a second humidity reading after the first humidity reading. Because tire sealant increases the humidity within a tire's interior, as described above with reference to FIG. 1, an increase in the humidity reading over time can indicate that sealant, or moisture associated with sealant, has migrated toward the valve stem 2111 and into fluid communication with the cap body 2106, a condition the tire pressure sensing device 2101 uses as a proxy for sealant presence at the valve-stem location, in place of the direct sealant-contact conductivity sensing described above with reference to FIG. 1, which is not practical to implement at an externally-mounted cap.

A controller 2102 is carried by the cap body 2106 and coupled to the humidity sensor 2107. The controller 2102 is configured to compare the second humidity reading to the first humidity reading and to generate a sealant-intrusion indication when the second humidity reading exceeds the first humidity reading by more than a threshold amount. In some examples, the first humidity reading is taken at or shortly after the cap body 2106 is threaded onto the valve stem 2111, providing a baseline reading against which subsequent readings are compared, and the second humidity reading is taken after an interval, or on demand, such as in response to a request received via the wireless transmitter 2104. In some examples, the threshold amount corresponds to a predetermined percentage increase in humidity relative to the first humidity reading. Between generation of the first humidity reading and generation of the second humidity reading, the controller 2102 may enter a low power state, reducing power drawn from the battery 2103.

A wireless transmitter 2104 is carried by the cap body 2106 and configured to transmit the pressure data and the sealant-intrusion indication to a remote device 2105, such as a mobile computing device executing an application of the kind described above with reference to FIG. 1. In some examples, the wireless transmitter 2104 comprises a Bluetooth transmitter configured to pair with the remote device 2105, providing continuous, longer-range communication as compared to the short-range, proximity-based near field communication described above with reference to FIG. 1. A battery 2103 is carried by the cap body 2106 and configured to power the pressure sensor 2108, the humidity sensor 2107, the controller 2102, and the wireless transmitter 2104. Because the tire pressure sensing device 2101 is mounted external to the tire at the valve stem 2111, the battery 2103 is accessible for replacement, and in some examples is removable from the cap body 2106 for that purpose, without requiring access to the interior of the tire.

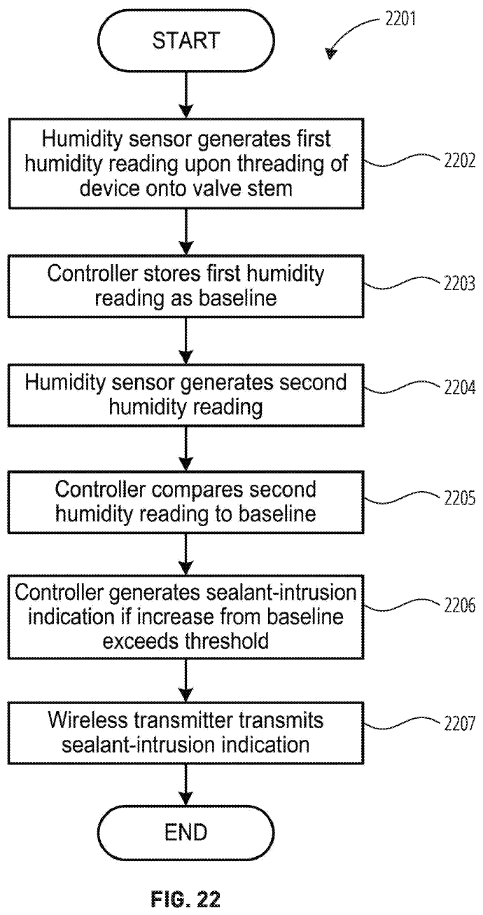

Referring to FIG. 22, a flowchart illustrates a sealant-intrusion detection method 2201, according to some examples, performed by the tire pressure sensing device 2101 (FIG. 21). The method 2201 begins with operation 2202, in which the humidity sensor 2107 generates a first humidity reading upon threading of the cap body 2106 (FIG. 21) onto the valve stem 2111 (FIG. 21) of a tire. Generating the first humidity reading at this point in the installation process establishes a baseline against which later readings may be compared, reflecting humidity conditions within the tire at or near the time the tire pressure sensing device 2101 is put into service.

At operation 2203, the controller 2102 stores the first humidity reading as a baseline reading, such as in a memory accessible to the controller 2102. At operation 2204, the humidity sensor 2107 generates a second humidity reading, taken after the first humidity reading; the second humidity reading may be generated after a predetermined interval has elapsed since the first humidity reading, in response to a request received via the wireless transmitter 2104 (FIG. 21), or on another schedule. In some examples, the controller 2102 enters a low power state between operation 2202 and operation 2204 to reduce power drawn from the battery 2103 (FIG. 21) while awaiting generation of the second humidity reading.

At operation 2205, the controller 2102 compares the second humidity reading generated at operation 2204 to the baseline reading stored at operation 2203. At operation 2206, the controller 2102 generates a sealant-intrusion indication when the comparison of operation 2205 indicates that the second humidity reading exceeds the baseline reading by more than a threshold amount. In some examples, the threshold amount corresponds to a predetermined percentage increase in humidity relative to the first humidity reading, such that the sealant-intrusion indication is generated when the second humidity reading represents at least that percentage increase over the baseline. If the comparison of operation 2205 does not indicate an increase exceeding the threshold amount, the method 2201 may return to operation 2204 to generate a further second humidity reading at a later time, allowing the tire pressure sensing device 2101 to continue monitoring for sealant intrusion over the service life of the tire.

At operation 2207, the wireless transmitter 2104 transmits the sealant-intrusion indication generated at operation 2206, such as to the remote device 2105 (FIG. 21) described above with reference to FIG. 21. In some examples, the wireless transmitter 2104 also transmits the pressure data generated by the pressure sensor 2108 (FIG. 21) together with the sealant-intrusion indication, or as part of a separate transmission, allowing the remote device 2105 to present both the tire pressure and the sealant-intrusion status to a user substantially as described above with reference to FIG. 9.

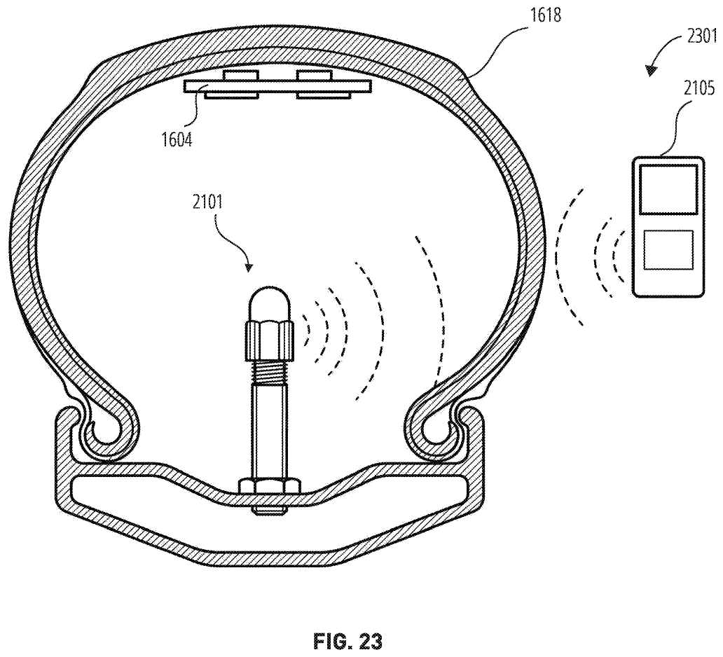

Referring to FIG. 23, a view illustrates a tire pressure sensing system 2301, according to some examples, in which a module 1604 (FIG. 16), including a module 1604 installed as part of the tire pressure sensing kit 2000 (FIG. 20), and a tire pressure sensing device 2101 (FIG. 21) are both mounted to the same tubeless tire 1618. The module 1604 is retained against an interior surface of the tubeless tire 1618 by a fastening structure, such as any of the fastening structures described above with reference to FIGS. 12-16, while the tire pressure sensing device 2101 is mounted to a valve stem of the tubeless tire 1618, as described above with reference to FIG. 21.

In the tire pressure sensing system 2301, the module 1604 and the tire pressure sensing device 2101 each wirelessly communicate, independently of one another, with a remote device 2105 (FIG. 21), such as a mobile computing device. Because the module 1604 and the tire pressure sensing device 2101 employ different sensing locations, power architectures, and wireless technologies, as described above with reference to FIGS. 12 and 17, the tire pressure sensing system 2301 allows redundant, complementary monitoring of the same tubeless tire 1618. For example, the module 1604 may provide sealant-contact-based sealant level data from within the tire interior when read at close range, while the tire pressure sensing device 2101 may provide continuous, longer-range pressure and sealant-intrusion data from the valve stem without a rider bringing a reader into close proximity with the tire.

In some examples, the remote device 2105 receiving data from both the module 1604 and the tire pressure sensing device 2101 presents the pressure, sealant, humidity, and sealant-intrusion data from both sources together on a single user interface, such as the user interface 816 described above with reference to FIG. 8, providing a combined view of the conditions within and at the tubeless tire 1618.

### Other Examples

### Wireless Sealant and Pressure Monitoring System for Tubeless Tires

Some examples of a wireless sealant and pressure monitoring system may be designed for use with tubeless tires. The system is particularly suited for monitoring the sealant level and air pressure within the tire, providing real-time data to ensure the tire's performance and safety.

### Wireless Sensor Module

The wireless sensor module is designed to be embedded within the tubeless tire, a strategic placement that allows it to directly interact with the tire's internal environment. This positioning is integral to the module's ability to accurately measure the tire's pressure and sealant levels. Being embedded within the tire, the module is in close proximity to the tire's interior surface, enabling it to detect even minor changes in pressure.

Furthermore, the module is not just embedded within the tire, but it is also immersed in the sealant. The sealant, a liquid substance that is added inside the tubeless tire, plays a pivotal role in the tire's performance and safety. It helps to maintain the seal between the tire and the rim, and can also rapidly seal small punctures that occur while the tire is in use. By being immersed in the sealant, the module is in direct contact with the sealant, allowing it to accurately measure the sealant level. This direct contact with the sealant enables the module to detect the presence and amount of sealant based on its ability to conduct electrical current, providing a direct and reliable indication of the sealant level inside the tubeless tire.

The module comprises a processing chip, a pressure-sensing chip, two or more electrical contacts, and a wireless antenna. The processing chip is the central unit of the module, responsible for data acquisition, processing, and communication with the wireless reader device. The pressure sensing chip is in communication with the processing chip and is responsible for measuring the air pressure inside the tubeless tire. The pressure sensing chip can be based on various technologies, including piezoresistive elements, which provide accurate pressure readings within the operational range of the tire.

The two or more electrical contacts are also in communication with the processing chip and are used to detect the level of sealant within the tubeless tire. The processing chip is configured to measure the conductivity between these contacts, which varies with the amount of sealant present, providing an indication of the sealant level.

The wireless antenna facilitates communication between the sensor module and the wireless reader device. It is designed to operate at frequencies suitable for short-range wireless communication technologies such as NFC, Bluetooth, or Wi-Fi.

### Wireless Communication Technologies

The wireless sensor module and wireless reader device can communicate using various wireless communication technologies. Near field communication (NFC) allows for close-range interactions and can also power the sensor module during data transactions. Bluetooth and Wi-Fi offer longer-range communication capabilities and are widely supported by modern mobile devices and computing platforms.

### Power Management

The wireless sensor module is designed to operate without an internal power source, relying instead on energy received from the wireless reader device during NFC transactions or other energy-harvesting methods. This design choice minimizes maintenance and allows the module to enter a low power state when not actively communicating, thereby extending its operational lifespan.

### Installation and Encapsulation

The wireless sensor module is adhered to an inside surface of the tubeless tire, which can be marked on the outside surface for accurate placement. The module is partially encapsulated by the sealant, except for the electrical contacts, to protect it from moisture and corrosion. A potting compound may be used to further protect the module's components, ensuring durability and reliability.

### Additional Sensors and Data Transmission

In addition to pressure and sealant level measurements, the wireless sensor module may include additional sensors, such as temperature and humidity sensors, to provide a comprehensive overview of the tire's condition. The module is configured to relay this data to the wireless reader device using an NFC data exchange format or other suitable communication protocols.

### Specific Components and Configurations

The wireless sensor module may incorporate specific components such as an NFC processing chip and a pressure sensing chip, such as the STMicroelectronics ILPS22QS chip. The NFC antenna can be integrated onto the module's printed circuit board or connected as a flexible antenna, depending on the design requirements.

The module's ability to detect changes in conductivity as the sealant level varies is a pivotal feature. An increase in conductivity indicates a higher level of sealant, while a decrease suggests a lower level. This dynamic monitoring capability is integral to maintaining the tire's performance and safety.

### Mounting and Weight Considerations

The design of the wireless sensor module takes into account its physical dimensions and weight to ensure that it does not negatively impact the balance or performance of the tire. The size and weight of the module are carefully optimized to fit within the limited space available inside the tire. This is a particularly challenging aspect of the design process, as the module has to be small and lightweight enough to fit within the tire without causing any imbalance or performance issues.

The diameter of the module is one of the primary considerations in its design. It has to be small enough to fit within the tire, but large enough to house all the components of the module, including the sensors, processing chip, and wireless transmitter. The diameter of the module is therefore optimized to provide a balance between size and functionality.

The thickness of the module is another major consideration. A thinner module can fit more easily within the tire and is less likely to cause any imbalance or performance issues. However, the module also has to be thick enough to protect the components from the harsh conditions inside the tire, including pressure, temperature, and moisture. The thickness of the module is therefore optimized to provide a balance between protection and performance.

The weight of the module is also a factor in its design. A heavier module could cause an imbalance in the tire, leading to performance issues. However, the module also has to be heavy enough to stay in place within the tire, especially during high-speed or off-road driving. The weight of the module is therefore optimized to provide a balance between stability and performance.

In summary, the design of the wireless sensor module involves careful consideration of its physical dimensions and weight. The module's diameter, thickness, and weight are all optimized to ensure that it fits within the tire's limited space without adversely affecting the tire's balance or performance.

Overall, the wireless sealant and pressure monitoring system provides a robust solution for real-time monitoring of tubeless tires, enhancing the safety and efficiency of vehicles equipped with such tires.

### Technical Solutions to Technical Problems

### Inaccurate Sealant Level Monitoring

One of the technical challenges that the disclosed system addresses is the inherent difficulty in accurately monitoring the level of sealant within tubeless tires. Traditional pressure sensors, which are primarily designed to measure air pressure, are not equipped to measure the presence of a liquid sealant. This is due to the fact that the physical properties of a liquid sealant are vastly different from those of air. As a result, when these traditional sensors come into contact with the sealant, they can produce inaccurate readings. Furthermore, the sealant can potentially cause damage to the sensors, leading to sensor failure and further inaccuracies in the readings.

However, the disclosed system provides a solution to this problem by incorporating an integrated wireless component with conductive sealant sensor pads and a current sensor (130). This innovative design allows for a direct indication of the sealant level by measuring the electrical current flowing between the sensor pads. The principle behind this method is that the sealant, being a conductive liquid, allows for the flow of electrical current. As such, the level of sealant within the tire can be inferred from the amount of current flowing between the sensor pads. This method of sealant level detection allows for accurate monitoring, which is pivotal for the tire's performance and safety. By accurately monitoring the sealant level, the system can alert the user when the sealant level falls below a threshold, thereby enabling timely replenishment of the sealant and ensuring the continued performance and safety of the tire.

### Sealant Distribution Variability

Another technical challenge that arises in the context of tubeless tires is the variability in the distribution of the sealant within the tire. The sealant, which is a liquid substance, is free to move around inside the tire. This mobility of the sealant can lead to uneven distribution, with some areas of the tire having more sealant than others. This variability in sealant distribution can affect the tire's ability to self-seal punctures effectively. In particular, areas of the tire with less sealant may be more prone to punctures, as there is not enough sealant to seal the puncture quickly and effectively. This can compromise the performance and safety of the tire, leading to a higher risk of tire failure and potential accidents.

To address this issue, the disclosed system incorporates a sealant monitoring system that can indicate variable sealant distribution within the tire. This system, as depicted in FIG. 3, measures the conductivity at different locations within the tire. The principle behind this method is that the sealant, being a conductive liquid, allows for the flow of electrical current. Therefore, by measuring the conductivity at different locations, the system can infer the distribution of the sealant within the tire.

When the sealant is evenly distributed throughout the tire, the conductivity at different locations will be approximately the same. However, if the sealant is unevenly distributed, the conductivity will vary between different locations. By monitoring these variations in conductivity, the system can detect areas of the tire with less sealant and alert the user to replenish the sealant in these areas. This ensures that the sealant is evenly distributed throughout the tire, enhancing the tire's ability to self-seal punctures and improving the overall performance and safety of the tire.

### Environmental Damage to Sensors

Tubeless tires, by their nature, are exposed to a variety of environmental conditions that can be detrimental to the functionality and lifespan of the sensors embedded within them. These conditions include moisture and corrosion, which can cause damage to the sensors and impair their ability to accurately measure tire pressure and sealant levels. Moisture can seep into the sensors and interfere with their electrical components, leading to inaccurate readings or even complete sensor failure. Similarly, corrosion can degrade the sensors over time, reducing their effectiveness and reliability.

Given these challenges, it is imperative to protect the sensors from these harsh environmental conditions to ensure their continued functionality and longevity. The disclosed wireless sensor module (102) addresses this issue by incorporating a protective encapsulation. This encapsulation is provided by a PCB potting sealant (108), as depicted in FIG. 1. The PCB potting sealant (108) forms a protective barrier around the wireless sensor module (100), shielding it from moisture and corrosion.

The PCB potting sealant (108) is a special type of sealant that is designed to withstand the harsh conditions inside a tubeless tire. It is resistant to moisture and corrosion, ensuring that it can effectively protect the wireless sensor module (100) from these damaging factors. The PCB potting sealant (108) is applied to encapsulate the wireless sensor module (100), covering all its components except for the two or more electrical contacts (126) that are used to measure the sealant level. These electrical contacts (126) are left exposed to the interior of the tubeless tire to enable them to come into contact with the sealant and measure its level.

By encapsulating the wireless sensor module (102) with the PCB potting sealant (108), the system enhances the durability and reliability of the monitoring system. This protective encapsulation ensures that the sensors can continue to accurately measure the tire pressure and sealant level, even in the face of harsh environmental conditions. This, in turn, enhances the safety and efficiency of vehicles equipped with tubeless tires, as it allows for accurate and reliable monitoring of tire pressure and sealant levels.

### Energy Consumption and Power Supply

Wireless sensor modules, such as those used in the disclosed system for monitoring tire pressure and sealant levels, typically require a power source to function. This power is used to operate the sensors, process the sensor data, and transmit the data wirelessly to an external device. However, managing the energy consumption of these sensor modules can be a challenging task, particularly in the context of a tire environment.

Tires, especially tubeless tires, present a harsh and demanding environment for electronic devices. They are exposed to a wide range of temperatures, pressures, and mechanical stresses, which can affect the performance and lifespan of the sensor modules. Moreover, the interior of a tire is a confined space with limited access, making it impractical to replace batteries or other power sources. This poses a challenge for the design and operation of wireless sensor modules, as they have to be self-sufficient in terms of power.

The solution to this challenge, as implemented in the disclosed system, involves the use of an NFC processor (116) connected to an NFC antenna (118). This setup allows the sensor module to harvest energy passively from NFC transactions. NFC, or Near Field Communication, is a wireless communication technology that allows for short-range communication between devices. During an NFC transaction, a small amount of energy is transferred from the NFC reader device to the NFC tag or sensor module. This energy can be harvested and used to power the sensor module.

By using this passive energy harvesting approach, the system can reduce the power requirements of the sensor module, thereby extending its operational lifespan and eliminating the dependency on an internal power source. This not only solves the problem of energy management in a tire environment but also enhances the reliability and convenience of the system. With this solution, the sensor module can continue to monitor the tire pressure and sealant levels accurately and reliably, even in the challenging environment of a tubeless tire.

### Real-Time Data Transmission

Transmitting real-time data from the sensors to an external device for monitoring can be challenging due to the limitations of wireless communication within the metal-rich environment of a tire and rim assembly. The metal components of the tire and rim can interfere with the wireless signals, causing signal loss or degradation. This can result in incomplete or inaccurate data transmission, which can compromise the effectiveness of the monitoring system.

Moreover, the confined space inside the tire can further exacerbate these challenges. The limited space can restrict the propagation of the wireless signals, making it difficult for the signals to reach the external device. This can lead to intermittent or unreliable data transmission, which can hinder real-time monitoring of the tire pressure and sealant levels.

To overcome these challenges, the wireless transmitter (150) is configured to communicate with external devices such as a mobile phone (110) using NFC or Bluetooth technology, as outlined in FIG. 9. Both NFC and Bluetooth technologies are designed to provide robust and reliable wireless communication even in challenging environments. They use advanced signal processing techniques to mitigate the effects of signal interference and loss, ensuring efficient and reliable data transmission.

NFC, or Near Field Communication, is particularly well-suited for short-range communication. It operates at a frequency that is less affected by the metal components of the tire and rim, allowing for efficient data transmission within the confined space of the tire. Bluetooth, on the other hand, is designed for longer-range communication. It uses a frequency hopping spread spectrum to avoid interference, ensuring reliable data transmission even over longer distances.

By leveraging these wireless communication technologies, the system can transmit real-time data from the sensors to the external device efficiently and reliably. This allows for real-time monitoring of the tire pressure and sealant levels, enhancing the safety and efficiency of vehicles equipped with tubeless tires.

### Sensor Data Integration and Display

Integrating various sensor data streams and presenting them in a user-friendly manner on an external device can be a complex task. This complexity arises from the diverse nature of the sensor data, which includes measurements of pressure, sealant level, humidity, and temperature. Each of these measurements is captured by a different sensor and may be represented in a different format or unit of measurement. Furthermore, the sensor data is dynamic, changing over time as the conditions inside the tire change. This dynamic nature of the sensor data adds another layer of complexity to the task of integration and presentation.

The NFC processor (118) plays a pivotal role in addressing this challenge. It serves as the central processing unit for the sensor data, receiving inputs from the pressure sensor (1144), sealant sensor (116), humidity sensor (122), and temperature sensor (124). The NFC processor (116) is designed to handle the diverse and dynamic nature of the sensor data. It processes the sensor data, converting it into a standardized format that can be easily transmitted and interpreted. This standardized format ensures that the sensor data is consistent and uniform, regardless of the specific sensor that generated it.

Once the sensor data has been processed and standardized, it is prepared for wireless transmission. This involves encoding the sensor data into a format that can be transmitted wirelessly, such as NFC or Bluetooth. The NFC processor (118) handles this encoding process, ensuring that the sensor data is packaged correctly for wireless transmission.

The final step in the process involves presenting the sensor data on an external device. This is achieved through a mobile application (112), which receives the wirelessly transmitted sensor data and displays it in an intuitive format for the user. The mobile application (112) is designed to present the sensor data in a user-friendly manner, making it easy for the user to understand and interpret the data. This includes visual representations of the sensor data, such as graphs or charts, as well as alerts or notifications if the sensor data indicates a potential issue with the tire. By integrating and presenting the sensor data in this manner, the system provides the user with a comprehensive and real-time overview of the conditions inside the tubeless tire.

### SENSOR INSTALLATION AND POSITIONING

Ensuring the correct installation and positioning of the sensor module within the tubeless tire is a factor for obtaining accurate measurements. However, achieving this can be a complex task due to the lack of a clear reference point within the tire's interior. The sensor module, being small and lightweight, can easily shift or rotate within the tire, leading to inaccurate readings of the sealant level and tire pressure. This can compromise the effectiveness of the monitoring system and lead to potential safety issues.

To address this challenge, an approach has been adopted in the design of the sensor module (100). The sensor module is adhered to the inside surface of the tubeless tire at a location that corresponds to an existing marking on the outside surface of the tire. This marking can be a manufacturer's logo, a specification label, or any other marking that is already present on the outside surface of the tire. By aligning the sensor module with this external marking, it can be accurately positioned within the tire, ensuring that it remains in the correct location for effective monitoring.

This innovative solution not only simplifies the installation process but also enhances the accuracy of the sensor module. By adhering the sensor module to a specific location within the tire, it is ensured that the sensor module remains stationary, even during tire rotation. This stationary positioning allows the sensor module to accurately measure the sealant level and tire pressure, enhancing the reliability and effectiveness of the monitoring system. Furthermore, this solution eliminates the guesswork involved in sensor module placement, making the installation process more straightforward and user-friendly.

### Dynamic Sealant Level Measurement

The inherent fluidity of the sealant used in tubeless tires presents a distinct challenge when it comes to accurately measuring its level. As the tire is in operation, the sealant moves freely within the tire's interior. This movement can cause fluctuations in the sealant level at any given point within the tire, making it difficult to obtain a precise measurement. Traditional methods of level measurement, which are typically designed for static or slow-moving liquids, may not provide accurate results in this dynamic environment.

To overcome this challenge, the system incorporates a novel approach to sealant level measurement that takes into account the fluid nature of the sealant. Specifically, the system is configured to detect the level of sealant by rotating the tubeless tire. This rotation causes the sealant to move over the sensor pads of the sealant sensor, changing the conductivity reading and providing a dynamic measure of the sealant level.

This method of sealant level detection leverages the fluidity of the sealant to provide a more accurate and representative measurement. As the tire rotates, the sealant flows over the sensor pads, creating a change in conductivity that directly corresponds to the sealant level at that particular point in the tire. By continuously monitoring this conductivity change as the tire rotates, the system can map the distribution of the sealant within the tire and accurately determine its overall level.

This dynamic measurement approach not only enhances the accuracy of the sealant level detection but also provides real-time data on the sealant distribution within the tire. This information can be invaluable for maintaining the performance and safety of the tire, as it allows the user to ensure that the sealant is evenly distributed throughout the tire and to replenish the sealant if it falls below the recommended level in any segment of the tire.

### EXAMPLES

Example 1 is a wireless sealant and pressure monitoring system for tubeless tires, the system comprising: a wireless sensor module configured to be embedded within a tubeless tire and immersed in a sealant, the wireless sensor module comprising: a processing chip; a pressure sensing chip in communication with the processing chip; two or more electrical contacts in communication with the processing chip, wherein the processing chip is configured to detect a level of sealant in the tubeless tire based on conductivity between the two or more electrical contacts; and a wireless antenna in communication with the processing chip; a wireless reader device configured to wirelessly communicate with the wireless sensor module.

In Example 2, the subject matter of Example 1 includes, wherein the wireless sensor module and the wireless reader device communicate using near field communication (NFC).

In Example 3, the subject matter of Example 2 includes, wherein the wireless sensor module is powered by energy received from the wireless reader device during an NFC transaction between the wireless sensor module and the wireless reader device.

In Example 4, the subject matter of Examples 1-3 includes, wherein the wireless sensor module and the wireless reader device communicate using Bluetooth.

In Example 5, the subject matter of Examples 1-4 includes, wherein the wireless sensor module and the wireless reader device communicate using Wi-Fi.

In Example 6, the subject matter of Examples 1-5 includes, wherein the processing chip is configured to detect the level of the sealant by pulsing a current between the two or more electrical contacts to measure the conductivity between the two or more electrical contacts.

In Example 7, the subject matter of Examples 1-6 includes, wherein the wireless sensor module does not comprise an internal power source.

In Example 8, the subject matter of Examples 1-7 includes, wherein the wireless sensor module is adhered to an inside surface of the tubeless tire.

In Example 9, the subject matter of Examples 1-8 includes, wherein the wireless sensor module is at least partially encapsulated by the sealant within the tubeless tire except for the two or more electrical contacts.

In Example 10, the subject matter of Examples 1-9 includes, wherein the sealant comprises a puncture sealant configured to seal punctures within the tubeless tire.

In Example 11, the subject matter of Examples 1-10 includes, wherein the wireless reader device is mounted to a bicycle frame.

In Example 12, the subject matter of Examples 1-11 includes, wherein the wireless sensor module is configured to enter a low power state when not communicating with the wireless reader device.

In Example 13, the subject matter of Examples 1-12 wherein the two or more electrical contacts of the wireless sensor module are spaced between 0.25 inches and 0.5 inches apart.

In Example 14, the subject matter of Examples 1-13 wherein the wireless sensor module has a diameter of less than 2 inches.

In Example 15, the subject matter of Examples 1-14 wherein the wireless sensor module has a thickness of less than 0.5 inches.

In Example 16, the subject matter of Examples 1-15 wherein the wireless sensor module weighs less than 50 grams.

In Example 17, the subject matter of Examples 1-16 includes, wherein the processing chip is further configured to detect a temperature within the tubeless tire, and wherein the wireless sensor module is further configured to relay temperature data to the wireless reader device.

In Example 18, the subject matter of Examples 1-17 includes, wherein the wireless sensor module further comprises a humidity sensor in communication with the processing chip, and wherein the processing chip is further configured to detect a humidity level within the tubeless tire based on input from the humidity sensor.

In Example 19, the subject matter of Example 18 includes, wherein the wireless sensor module is further configured to relay humidity level data to the wireless reader device.

In Example 20, the subject matter of Examples 1-19 includes, wherein the wireless sensor module is adhered to an inside surface of the tubeless tire at a location marked on an outside surface of the tubeless tire.

In Example 21, the subject matter of Examples 1-20 includes, wherein the wireless sensor module is adhered to an inside surface of the tubeless tire at a location corresponding to an existing marking on an outside surface of the tubeless tire.

In Example 22, the subject matter of Examples 1-21 includes, wherein the wireless sensor module is at least partially encapsulated within a potting compound configured to protect the wireless sensor module from moisture and corrosion.

In Example 23, the subject matter of Example 22 includes, wherein the potting compound encapsulates the wireless sensor module except for the two or more electrical contacts.

In Example 24, the subject matter of Examples 1-23 includes, wherein the wireless sensor module is configured to relay tire pressure data, sealant level data, and temperature data to the wireless reader device using an NFC data exchange format.

In Example 25, the subject matter of Examples 1-24 includes, wherein the wireless sensor module comprises an NFC processing chip.

In Example 26, the subject matter of Examples 1-25 includes, wherein the pressure sensing chip comprises an STMicroelectronics ILPS22QS chip.

In Example 27, the subject matter of Examples 1-26 includes, wherein the wireless sensor module comprises an NFC antenna integrated onto a printed circuit board of the wireless sensor module.

In Example 28, the subject matter of Examples 1-27 includes, wherein the wireless sensor module comprises a flexible NFC antenna connected to a printed circuit board of the wireless sensor module.

In Example 29, the subject matter of Examples 1-28 includes, wherein the wireless sensor module is configured to detect an increased conductivity between the two or more electrical contacts as the level of sealant increases.

In Example 30, the subject matter of Examples 1-29 includes, wherein the wireless sensor module is configured to detect a decreased conductivity between the two or more electrical contacts as the level of sealant decreases.

Example 31 is a wireless sealant monitoring system for tubeless tires comprising: an integrated wireless component positioned inside a tubeless tire, the integrated wireless component further comprising: a first conductive sealant sensor pad; a second conductive sealant sensor pad, wherein the first and second sealant sensor pads are exposed to an interior of the tubeless tire; a current sensor electrically connected to the first and second sealant sensor pads, the current sensor configured to measure an electrical current flowing between the first and second sealant sensor pads; and a wireless transmitter in communication with the current sensor, the wireless transmitter configured to transmit data corresponding to the measured electrical current.

In Example 32, the subject matter of Example 31 includes, wherein the integrated wireless component is further comprised of a flexible substrate, and wherein the first conductive sealant sensor pad, the second conductive sealant sensor pad, the current sensor, and the wireless transmitter are attached to the flexible substrate.

In Example 33, the subject matter of Example 32 includes, wherein the flexible substrate enables the integrated wireless component to conform to an interior surface of the tubeless tire.

In Example 34, the subject matter of Examples 31-33 includes, wherein the wireless transmitter is a near field communication (NFC) transmitter.

In Example 35, the subject matter of Examples 31-34 includes, wherein the first and second conductive sealant sensor pads are positioned approximately ¼ inch apart.

Example 36 is a method for monitoring a sealant level in a tubeless tire, the method comprising: positioning an integrated wireless component inside the tubeless tire, the integrated wireless component comprising first and second conductive sealant sensor pads exposed to an interior of the tubeless tire; measuring, using a current sensor electrically connected to the first and second sealant sensor pads, an electrical current flowing between the first and second sealant sensor pads; and transmitting, by a wireless transmitter, data corresponding to the measured electrical current.

Example 37 is a wireless sealant and pressure monitoring system for tubeless tires comprising: an integrated wireless component positioned inside a tubeless tire, the integrated wireless component further comprising: a first conductive sealant sensor pad; a second conductive sealant sensor pad, wherein the first and second sealant sensor pads are exposed to an interior of the tubeless tire; a current sensor electrically connected to the first and second sealant sensor pads, the current sensor configured to measure an electrical current flowing between the first and second sealant sensor pads; a pressure sensor for measuring a pressure inside the tubeless tire; a wireless transmitter in communication with the current sensor and pressure sensor, the wireless transmitter configured to transmit data corresponding to the measured electrical current and measured pressure.

In Example 38, the subject matter of Example 37 includes, wherein the pressure sensor is a piezoresistive pressure sensor.

In Example 39, the subject matter of Example 38 wherein the piezoresistive pressure sensor is configured to measure pressures in a range of 5 to 60 PSI

In Example 40, the subject matter of Examples 37-39 includes, wherein the pressure sensor is in communication with the current sensor.

In Example 41, the subject matter of Example 40 includes, wherein the current sensor provides power to the pressure sensor.

In Example 42, the subject matter of Examples 37-41 includes, a sealant level alert system and a tire pressure alert system in communication with the wireless transmitter.

In Example 43, the subject matter of Example 42 includes, wherein: the sealant level alert system determines a sealant level based on the data transmitted by the wireless transmitter corresponding to the measured electrical current; and the tire pressure alert system determines a tire pressure based on the data transmitted by the wireless transmitter corresponding to the measured pressure.

In Example 44, the subject matter of Example 43 includes, wherein: the sealant level alert system provides an alert if the determined sealant level is below a threshold level; and the tire pressure alert system provides an alert if the determined tire pressure is above or below threshold pressure levels.

Example 45 is a method for monitoring a sealant level in a tubeless tire, the method comprising: measuring a pressure inside the tubeless tire using a pressure sensor; transmitting, by a wireless transmitter, data corresponding to the measured pressure; determining, by a tire pressure alert system, a tire pressure based on the transmitted data corresponding to the measured pressure; and providing, by the tire pressure alert system, an alert if the determined tire pressure is above or below threshold pressure levels.

Example 46 is a wireless sealant and pressure monitoring system for tubeless tires comprising: an integrated wireless component positioned inside a tubeless tire, the integrated wireless component further comprising: a first conductive sealant sensor pad; a second conductive sealant sensor pad, wherein the first and second sealant sensor pads are exposed to an interior of the tubeless tire; a current sensor electrically connected to the first and second sealant sensor pads, the current sensor configured to measure an electrical current flowing between the first and second sealant sensor pads; a pressure sensor for measuring a pressure inside the tubeless tire; a wireless transmitter in communication with the current sensor and pressure sensor, the wireless transmitter configured to transmit data corresponding to the measured electrical current and measured pressure.

In Example 47, the subject matter of Example 46 includes, wherein the pressure sensor is a piezoresistive pressure sensor.

In Example 48, the subject matter of Example 47 wherein the piezoresistive pressure sensor is configured to measure pressures in a range of 5 to 60 PSI

In Example 49, the subject matter of Examples 46-48 includes, wherein the pressure sensor is in communication with the current sensor.

In Example 50, the subject matter of Example 49 includes, wherein the current sensor provides power to the pressure sensor.

In Example 51, the subject matter of Examples 46-50 includes, a sealant level alert system and a tire pressure alert system in communication with the wireless transmitter.

In Example 52, the subject matter of Example 51 includes, wherein: the sealant level alert system determines a sealant level based on the data transmitted by the wireless transmitter corresponding to the measured electrical current; and the tire pressure alert system determines a tire pressure based on the data transmitted by the wireless transmitter corresponding to the measured pressure.

In Example 53, the subject matter of Example 52 includes, wherein: the sealant level alert system provides a first alert based on the determined sealant level being below a threshold level; and the tire pressure alert system provides a second alert based on the determined tire pressure being above or below threshold pressure levels.

Example 54 is a wireless sealant and pressure monitoring module for tubeless tires, comprising: a sealant sensor configured to measure sealant levels inside a tubeless tire; a pressure sensor configured to measure air pressure inside the tubeless tire; a wireless transmitter in communication with the sealant sensor and the pressure sensor, the wireless transmitter configured to transmit wireless signals corresponding to the measured sealant levels and tire pressure; a flexible substrate, wherein the sealant sensor, the pressure sensor, and the wireless transmitter are attached to the flexible substrate; an adhesive coating disposed on the flexible substrate for attaching the wireless sealant and pressure monitoring module to an interior surface of the tubeless tire; and a first and second conductive sealant sensor pad electrically connected to the sealant sensor, wherein the flexible substrate conforms to the interior surface of the tubeless tire such that the first and second conductive sealant sensor pads are exposed to sealant inside the tire.

Example 55 is a tire pressure sensor assembly comprising: a module comprising a support structure, a pressure sensor carried by the support structure and configured to generate pressure data indicative of a pressure within a tubeless tire, and a wireless transmitter carried by the support structure and configured to wirelessly transmit the pressure data; and a fastening structure engaging a retention feature of the support structure and mechanically retaining the module against an interior surface of the tubeless tire.

In Example 56, the subject matter of Example 55 includes, wherein the fastening structure is distinct from the support structure.

In Example 57, the subject matter of Examples 55-56 includes, wherein the retention feature comprises an aperture extending through the support structure, and wherein the fastening structure comprises a post having a proximal portion and a distal portion, the distal portion having a transverse dimension greater than a transverse dimension of the aperture, the post extending through the aperture such that the distal portion is disposed on a side of the support structure opposite the interior surface of the tubeless tire.

In Example 58, the subject matter of Example 57 includes, wherein the post tapers from the proximal portion to the distal portion, the taper configured to permit the distal portion to be pushed through the aperture.

In Example 59, the subject matter of Example 57 includes, wherein the post comprises an elastically deformable material configured to be stretched to reduce the transverse dimension of the distal portion for insertion through the aperture, and to relax to the transverse dimension greater than the transverse dimension of the aperture after the insertion.

In Example 60, the subject matter of Example 57 includes, wherein the post is integrally formed with the interior surface of the tubeless tire.

In Example 61, the subject matter of Examples 57-60 includes, further comprising a retainer clip engaging the distal portion of the post on the side of the support structure opposite the interior surface of the tubeless tire.

In Example 62, the subject matter of Examples 55-56 includes, wherein the retention feature comprises an edge of the support structure, and wherein the fastening structure comprises a flexible pocket receiving the edge of the support structure and retaining the edge against the interior surface of the tubeless tire.

In Example 63, the subject matter of Examples 55-56 includes, wherein the fastening structure comprises a plug body received in sealing engagement within a hole formed through a carcass of the tubeless tire, and wherein the sealing engagement seals the hole against loss of tire sealant through the hole independently of the mechanical retention of the module by the fastening structure.

In Example 64, the subject matter of Examples 55-63 includes, wherein the wireless transmitter comprises a near field communication processor and a near field communication antenna, and wherein the module is configured to harvest energy from near field communications received by the near field communication antenna for powering the pressure sensor and the wireless transmitter.

In Example 65, the subject matter of Examples 55-64 includes, further comprising a sealant sensor carried by the support structure and configured to measure an electrical conductivity within the tubeless tire to generate sealant level data, the wireless transmitter further configured to wirelessly transmit the sealant level data.

In Example 66, the subject matter of Examples 55-65 includes, further comprising a humidity sensor carried by the support structure and configured to generate humidity data, and a temperature sensor carried by the support structure and configured to generate temperature data, the wireless transmitter further configured to wirelessly transmit the humidity data and the temperature data.

In Example 67, the subject matter of Examples 55-66 includes, wherein the module is configured to enter a low power state between wireless communication transactions.

In Example 68, the subject matter of Examples 55-67 includes, wherein the support structure is at least partially encapsulated by a potting sealant, with the pressure sensor, and any sealant sensor, humidity sensor, or temperature sensor carried by the support structure, remaining exposed through the potting sealant for operation.

Example 69 is a method of installing the module of any of Examples 55-68 to a tubeless tire, the method comprising: positioning the module against an interior surface of the tubeless tire; and engaging the fastening structure with the retention feature of the support structure to mechanically retain the module against the interior surface.

Example 70 is a method of manufacturing a tubeless tire for use with the module of any of Examples 55-56, the method comprising: forming a fastening structure integrally with an interior wall of the tubeless tire during manufacture of the tubeless tire, the fastening structure configured to engage a retention feature of a support structure of the module to mechanically retain the module against the interior wall.

Example 71 is a tire pressure sensing kit comprising: a plug body comprising a first portion sized for insertion into and sealing engagement with a hole formed through a carcass of a tubeless tire, and a second portion extending from the first portion to a distal end, the distal end having a first transverse dimension; and a module comprising a support structure defining an aperture extending through the support structure, a pressure sensor carried by the support structure and configured to generate pressure data indicative of a pressure within the tubeless tire, and a wireless transmitter carried by the support structure and configured to wirelessly transmit the pressure data, the aperture having a second transverse dimension smaller than the first transverse dimension of the distal end, the second portion of the plug body configured to extend through the aperture with the distal end disposed on a side of the support structure opposite the first portion of the plug body, the sealing engagement of the first portion within the hole sealing the hole against loss of tire sealant through the hole independently of retention of the module by the second portion of the plug body.

In Example 72, the subject matter of Example 71 includes, wherein the plug body comprises an elastically deformable material.

In Example 73, the subject matter of Examples 71-72 includes, wherein the wireless transmitter comprises a near field communication processor and a near field communication antenna, the module configured to harvest energy from near field communications received by the near field communication antenna for powering the pressure sensor and the wireless transmitter.

In Example 74, the subject matter of Examples 71-73 includes, further comprising a sealant sensor carried by the support structure and configured to measure an electrical conductivity within the tubeless tire to generate sealant level data, the wireless transmitter further configured to wirelessly transmit the sealant level data.

Example 75 is a method of installing the tire pressure sensing kit of any of Examples 71-74 into a tubeless tire, the method comprising: inserting the first portion of the plug body into a hole formed through a carcass of the tubeless tire to form the sealing engagement; and passing the second portion of the plug body through the aperture of the support structure until the distal end of the plug body is disposed on the side of the support structure opposite the first portion of the plug body.

Example 76 is a tire pressure sensing device comprising: a housing comprising an engagement structure configured to mount the housing onto a valve stem of a tire and to actuate a valve core of the valve stem while the housing is mounted onto the valve stem, the actuation placing an interior of the tire in fluid communication with an interior of the housing; a battery disposed within the housing; a pressure sensor disposed within the housing, electrically coupled to the battery, and configured to generate pressure data indicative of a pressure within the tire; a humidity sensor disposed within the housing, electrically coupled to the battery, and configured to generate humidity data indicative of a humidity within the tire; and a wireless transmitter disposed within the housing, electrically coupled to the battery, the pressure sensor, and the humidity sensor, and configured to wirelessly transmit the pressure data and the humidity data.

In Example 77, the subject matter of Example 76 includes, wherein the engagement structure comprises a pin extending from the housing, the pin positioned to depress the valve core when the housing is mounted onto the valve stem.

In Example 78, the subject matter of Examples 76-77 includes, wherein the housing comprises a cap body having an internally threaded portion configured to engage an externally threaded portion of the valve stem.

In Example 79, the subject matter of Examples 76-78 includes, further comprising a controller disposed within the housing and coupled to the humidity sensor, the humidity sensor configured to generate a first humidity reading and a second humidity reading after the first humidity reading, the controller configured to compare the second humidity reading to the first humidity reading and to generate a sealant-intrusion indication when the second humidity reading exceeds the first humidity reading by more than a threshold amount, the wireless transmitter further configured to wirelessly transmit the sealant-intrusion indication to a remote device.

In Example 80, the subject matter of Examples 76-79 includes, wherein the wireless transmitter comprises a Bluetooth transmitter configured to pair with a mobile computing device.

In Example 81, the subject matter of Examples 76-80 includes, wherein the battery is removable from the housing for replacement.

In Example 82, the subject matter of Examples 79-81 includes, wherein the controller is further configured to enter a low power state between generation of the first humidity reading and generation of the second humidity reading.

In Example 83, the subject matter of Examples 79-82 includes, wherein the threshold amount corresponds to a predetermined percentage increase in humidity relative to the first humidity reading.

Example 84 is a tire pressure sensing system comprising: the housing of any of Examples 76-78, 80, or 81; and a mobile computing device comprising an application configured to receive the pressure data and the humidity data from the wireless transmitter, the humidity data comprising a first humidity reading and a second humidity reading generated after the first humidity reading, the application further configured to generate a sealant-intrusion indication when the second humidity reading exceeds the first humidity reading by more than a threshold amount.

Example 85 is a method of detecting an intrusion of tire sealant into the housing of any of Examples 76-78, the housing mounted onto a valve stem of a tire, the method comprising: generating, using a pressure sensor disposed within the housing, pressure data indicative of a pressure within the tire; generating, using a humidity sensor disposed within the housing, a first humidity reading; generating, using the humidity sensor, a second humidity reading after the first humidity reading; comparing the second humidity reading to the first humidity reading; and generating a sealant-intrusion indication when the second humidity reading exceeds the first humidity reading by more than a threshold amount.

Example 86 is a tire pressure sensing system comprising: a tire pressure sensor assembly according to any of Examples 55-68, or a tire pressure sensing kit according to any of Examples 71-74, mounted to or installed in a tubeless tire; and a tire pressure sensing device according to any of Examples 76-83, the tire pressure sensing device mounted to a valve stem of the tubeless tire.

Example 87 is a system comprising: the tire pressure sensor assembly of any of Examples 55-68, or the tire pressure sensing kit of any of Examples 71-74, installed in a tubeless tire; and a relay device comprising a near field communication reader and a Bluetooth transmitter, the relay device configured to receive near field communication transmissions from the wireless transmitter of the tire pressure sensor assembly or the tire pressure sensing kit and to convert the near field communication transmissions to Bluetooth signals for relay to a mobile device, wherein the wireless transmitter comprises a near field communication processor and a near field communication antenna.

In Example 88, the subject matter of any of Examples 55-87 includes, wherein a humidity sensor thereof comprises a moisture sensor configured to generate moisture data indicative of a moisture condition within the tubeless tire.

In Example 89, the subject matter of any of Examples 55-88 includes, further comprising a capacitance sensor configured to generate sealant level data or moisture data based on a capacitance measurement within the tubeless tire.

Example 90 is at least one machine-readable medium including instructions that, when executed by processing circuitry, cause the processing circuitry to perform operations to implement of any of Examples 1-89.

Example 91 is an apparatus comprising means to implement of any of Examples 1-89.

Example 92 is a system to implement of any of Examples 1-89.

Example 93 is a method to implement of any of Examples 1-89.

What is claimed is:

1. A tire pressure sensor assembly comprising:
a module comprising a support structure, a pressure sensor carried by the support structure and configured to generate pressure data indicative of a pressure within a tubeless tire, and a wireless transmitter carried by the support structure and configured to wirelessly transmit the pressure data; and
a fastening structure distinct from the support structure, the fastening structure engaging a retention feature of the support structure and mechanically retaining the module against an interior surface of the tubeless tire.

2. The tire pressure sensor assembly of claim 1, wherein the fastening structure comprises a plug body received in sealing engagement within a hole formed through a carcass of the tubeless tire, and wherein the sealing engagement seals the hole against loss of tire sealant through the hole independently of the mechanical retention of the module by the fastening structure.

3. The tire pressure sensor assembly of claim 1, wherein the retention feature comprises an aperture extending through the support structure, and wherein the fastening structure comprises a post having a proximal portion and a distal portion, the distal portion having a transverse dimension greater than a transverse dimension of the aperture, the post extending through the aperture such that the distal portion is disposed on a side of the support structure opposite the interior surface of the tubeless tire.

4. The tire pressure sensor assembly of claim 3, wherein the post tapers from the proximal portion to the distal portion, the taper configured to permit the distal portion to be pushed through the aperture.

5. The tire pressure sensor assembly of claim 3, wherein the post comprises an elastically deformable material configured to be stretched to reduce the transverse dimension of the distal portion for insertion through the aperture, and to relax to the transverse dimension greater than the transverse dimension of the aperture after the insertion.

6. The tire pressure sensor assembly of claim 3, wherein the post is integrally formed with the interior surface of the tubeless tire.

7. The tire pressure sensor assembly of claim 3, further comprising a retainer clip engaging the distal portion of the post on the side of the support structure opposite the interior surface of the tubeless tire.

8. The tire pressure sensor assembly of claim 1, wherein the retention feature comprises an edge of the support structure, and wherein the fastening structure comprises a flexible pocket receiving the edge of the support structure and retaining the edge against the interior surface of the tubeless tire.

9. The tire pressure sensor assembly of claim 1, wherein the wireless transmitter comprises a near field communication processor and a near field communication antenna, and wherein the module is configured to harvest energy from near field communications received by the near field communication antenna for powering the pressure sensor and the wireless transmitter.

10. The tire pressure sensor assembly of claim 1, further comprising a sealant sensor carried by the support structure and configured to measure an electrical conductivity within the tubeless tire to generate sealant level data, the wireless transmitter further configured to wirelessly transmit the sealant level data.

11. The tire pressure sensor assembly of claim 1, further comprising a humidity sensor carried by the support structure and configured to generate humidity data, and a temperature sensor carried by the support structure and configured to generate temperature data, the wireless transmitter further configured to wirelessly transmit the humidity data and the temperature data.

12. A tire pressure sensing kit comprising:
a plug body comprising a first portion sized for insertion into and sealing engagement with a hole formed through a carcass of a tubeless tire, and a second portion extending from the first portion to a distal end, the distal end having a first transverse dimension; and
a module comprising a support structure defining an aperture extending through the support structure, a pressure sensor carried by the support structure and configured to generate pressure data indicative of a pressure within the tubeless tire, and a wireless transmitter carried by the support structure and configured to wirelessly transmit the pressure data, the aperture having a second transverse dimension smaller than the first transverse dimension of the distal end, the second portion of the plug body configured to extend through the aperture with the distal end disposed on a side of the support structure opposite the first portion of the plug body,
the sealing engagement of the first portion within the hole sealing the hole against loss of tire sealant through the hole independently of retention of the module by the second portion of the plug body.

13. The tire pressure sensing kit of claim 12, wherein the plug body comprises an elastically deformable material.

14. The tire pressure sensing kit of claim 12, wherein the wireless transmitter comprises a near field communication processor and a near field communication antenna, the module configured to harvest energy from near field communications received by the near field communication antenna for powering the pressure sensor and the wireless transmitter.

15. The tire pressure sensing kit of claim 12, further comprising a sealant sensor carried by the support structure and configured to measure an electrical conductivity within the tubeless tire to generate sealant level data, the wireless transmitter further configured to wirelessly transmit the sealant level data.

16. A tire pressure sensing device comprising:
a cap body configured to thread onto a valve stem of a tire;
a pin extending from the cap body, the pin positioned to depress a valve core of the valve stem when the cap body is threaded onto the valve stem, thereby placing an interior of the tire in fluid communication with the cap body;
a pressure sensor carried by the cap body and configured to generate pressure data indicative of a pressure within the tire;
a humidity sensor carried by the cap body and configured to generate a first humidity reading upon threading of the cap body onto the valve stem and to generate a second humidity reading after the first humidity reading;
a controller carried by the cap body, coupled to the humidity sensor, and configured to compare the second humidity reading to the first humidity reading and to generate a sealant-intrusion indication when the second humidity reading exceeds the first humidity reading by more than a threshold amount;
a wireless transmitter carried by the cap body and configured to transmit the pressure data and the sealant-intrusion indication to a remote device; and
a battery carried by the cap body and configured to power the pressure sensor, the humidity sensor, the controller, and the wireless transmitter.

17. The tire pressure sensing device of claim 16, wherein the wireless transmitter comprises a Bluetooth transmitter configured to pair with a mobile computing device.

18. The tire pressure sensing device of claim 16, wherein the battery is removable from the cap body for replacement.

19. The tire pressure sensing device of claim 16, wherein the controller is further configured to enter a low power state between generation of the first humidity reading and generation of the second humidity reading.

20. The tire pressure sensing device of claim 16, wherein the threshold amount corresponds to a predetermined percentage increase in humidity relative to the first humidity reading.
